(19) United States
(12) Patent Application Publication
(10) Pub. No.: US 2026/0128777 A1
(43) Pub. Date: May 7, 2026

(54) COMMUNICATION METHOD AND RELATED DEVICE

(71) Applicant: HUAWEI TECHNOLOGIES CO., LTD., Shenzhen (CN)

(72) Inventors: Jian Wang, Hangzhou (CN); Gongzheng Zhang, Hangzhou (CN); Rong Li, Boulogne Billancourt (FR)

(73) Assignee: HUAWEI TECHNOLOGIES CO., LTD., Shenzhen (CN)

(21) Appl. No.: 19/435,994

(22) Filed: Dec. 30, 2025

Related U.S. Application Data
(63) Continuation of application No. PCT/CN2023/104750, filed on Jun. 30, 2023.

(51) Int. Cl. H04B 7/06; H04L 25/02

(52) U.S. Cl. CPC H04B 7/0626; H04B 7/063; H04L 25/0254

(57) ABSTRACT

A communication method and a related device, to improve processing efficiency and reduce a processing delay in a wireless policy optimization process in a manner of determining channel characteristic information by using a neural network, to improve communication efficiency. In the method, a first device determines first information, where the first information indicates channel characteristic information between the first device and a second device, and the first information is obtained by a first neural network by processing channel information of the first device. The first device sends the first information.

### CROSS-REFERENCE TO RELATED APPLICATIONS

This application is a continuation n of International Application No. PCT/CN2023/104750, filed on Jun. 30, 2023, the disclosure of which is hereby incorporated by reference in its entirety.

### TECHNICAL FIELD

The embodiments relate to the field of communication, for example, to a communication method and a related device.

### BACKGROUND

Wireless communication may be transmission communication performed between a plurality of communication nodes without propagation through a conductor or a cable. A network device and a terminal device may be used as different communication nodes to perform communication in a wireless communication manner. In a communication system, wireless policy optimization (for example, resource allocation, channel estimation, and signal detection) is an important issue in wireless communication.

However, how to improve processing efficiency and reduce a processing delay in an implementation process of wireless policy optimization is an urgent problem to be resolved.

### SUMMARY

The embodiments provide a communication method and a related device, to improve processing efficiency and reduce a processing delay in a wireless policy optimization process in a manner of determining channel characteristic information by using a neural network, to improve communication efficiency.

A first aspect of embodiments provides a communication method. The method is performed by a first device. Alternatively, the method is performed by a part of components (for example, a processor, a chip, or a chip system) in a first device. Alternatively, the method may be implemented by a logical module or software that can implement all or a part of functions of a first device. In the first aspect and a possible embodiment of the first aspect, an example in which the method is performed by the first device is used for description. The first device may be a terminal device or a network device. In the method, the first device determines first information, where the first information indicates channel characteristic information between the first device and a second device, and the first information is obtained by a first neural network by processing channel information of the first device. The first device sends the first information.

According to the foregoing solution, the first information sent by the first device indicates the channel characteristic information between the first device and the second device, and the first information is obtained by the first neural network by processing the channel information of the first device. In other words, the first device may obtain, through neural network processing, the channel characteristic information for wireless policy optimization. Subsequently, after the first device sends the first information indicating the channel characteristic information, a receiver of the first information can implement wireless policy optimization based on the first information. Therefore, determining the channel characteristic information by using a neural network can improve processing efficiency and reduce a processing delay in a wireless policy optimization process, to improve communication efficiency.

Optionally, the channel characteristic information indicated by the first information may include a channel eigenvalue and/or a channel eigenvector. Alternatively, the channel characteristic information indicated by the first information may include other information indicating a channel characteristic. The channel eigenvalue and/or the channel eigenvector may alternatively be other names, for example, a channel characteristic parameter.

It should be understood that the channel information of the first device may include at least one of channel information of a channel between the first device and the second device and channel information of a channel between the second device and the first device. The receiver of the first information may be the second device. The second device may be a terminal device or a network device. The channel has a plurality of possible forms.

For example, when the first device is a terminal device and the second device is a network device, the channel between the first device and the second device may be an uplink channel, and the channel between the second device and the first device may be a downlink channel.

For another example, when the first device is a network device and the second device is a terminal device, the channel between the first device and the second device may be a downlink channel, and the channel between the second device and the first device may be an uplink channel.

For another example, when the first device is a terminal device and the second device is a terminal device, the channel between the first device and the second device may be a sidelink communication channel.

For another example, when the first device is a network device and the second device is a network device, the channel between the first device and the second device may be a backhaul link communication channel.

In a possible embodiment of the first aspect, the first neural network includes a first module, a second module, and a third module. The first module is used to perform randomized range finder (RRF) processing on the channel information of the first device to obtain an RRF result. The second module is used to perform low rank approximation (LRA) processing on the channel information of the first device and the RRF result to obtain an LRA result. The third module is used to perform singular value decomposition (SVD) processing on the LRA result to obtain the first information.

According to the foregoing solution, the first neural network may include the first module used to perform RRF processing, the second module used to perform LRA processing, and the third module used to perform SVD processing. In other words, the first information is obtained by sequentially performing RRF processing, LRA processing, and SVD processing on the channel information of the first device, to provide an implementation of neural network processing.

In a possible embodiment of the first aspect, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

According to the foregoing solution, the matrix dimension of the matrix representation of the channel information of the first device is m×n, the matrix dimension of the matrix representation of the LRA result used by the third module in the first neural network to perform SVD processing is l×n, and the value of l is less than that of m. Therefore, compared with a process of performing SVD on the channel information in an eigen zero forcing (EZF) manner, to obtain the channel characteristic information, in the foregoing process of obtaining the LRA result through LRA processing and performing SVD processing on the LRA result, because complexity of performing SVD on the LRA result is less than that of performing SVD on the channel information, the processing efficiency can be further improved, and the processing delay can be further reduced.

In a possible embodiment of the first aspect, the first module includes a first submodule, a second submodule, and a third submodule. The first submodule is used to perform data preprocessing on the channel information of the first device based on a preprocessing parameter, to obtain a preprocessing result. The second submodule is used to perform randomized neural network processing on the preprocessing result based on the oversampling parameter, to obtain a randomized neural network processing result. The third submodule is used to perform orthogonal triangular (QR-decomposition, QR) decomposition processing on the randomized neural network processing result to obtain the RRF result.

According to the foregoing solution, in a process in which the first module in the first neural network performs RRF processing on the channel information of the first device to obtain the RRF result, a neural network processing process may be affected by using the preprocessing parameter and the oversampling parameter, and the RRF result is determined by sequentially performing processing by using the first submodule, the second submodule, and the third submodule in the first module.

Optionally, in some embodiments, a performance-complexity trade-off can be implemented by adjusting the preprocessing parameter and/or the oversampling parameter (for example, parameter tuning), to adapt to different performance requirements or complexity requirements.

In a possible embodiment of the first aspect, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

According to the foregoing solution, when the second submodule in the first neural network performs randomized neural network processing on the preprocessing result based on the oversampling parameter, to obtain the randomized neural network processing result, performance and complexity of the second submodule may be adjusted by adjusting a value of T, to improve flexibility of implementing the solution, to adapt to different performance requirements or complexity requirements.

In a possible embodiment of the first aspect, that the first information is obtained by the first neural network by processing the channel information of the first device includes: the first information is obtained by the first neural network by processing the channel information of the first device based on a first parameter, where the first parameter includes the oversampling parameter and/or the preprocessing parameter.

According to the foregoing solution, the first information indicating the channel characteristic information between the first device and the second device may be obtained by processing the channel information of the first device based on the first parameter. Therefore, the performance-complexity trade-off can be implemented by adjusting the first parameter (for example, parameter tuning), to adapt to different performance requirements or complexity requirements.

In a possible embodiment of the first aspect, the method further includes: the first device receives indication information indicating the oversampling parameter and/or the preprocessing parameter.

According to the foregoing solution, after receiving the indication information indicating the oversampling parameter and/or the preprocessing parameter, the first device may determine the first information based on the indication information. In other words, the foregoing solution may be applicable to an implementation scenario in which another device (for example, the second device) determines/indicates the oversampling parameter and/or the preprocessing parameter. Therefore, implementation complexity of the first device can be reduced, and the second device can flexibly configure performance and/or complexity of a plurality of pieces of first information obtained by a plurality of first devices that may exist.

In a possible embodiment of the first aspect, the method further includes: the first device sends indication information indicating the oversampling parameter and/or the preprocessing parameter.

According to the foregoing solution, when the oversampling parameter and/or the preprocessing parameter are/is preconfigured on the first device, the first device may further send, to another device (for example, the second device), the indication information indicating the oversampling parameter and/or the preprocessing parameter, so that another device can determine a performance and/or complexity configuration of the first device based on the indication information.

In addition, in the foregoing solution, the first device can determine the oversampling parameter and/or the preprocessing parameter without an indication from another device, so that signaling overheads can be reduced, and the first device can implement the performance and/or complexity configuration based on local computing power (or redundant computing power).

A second aspect of embodiments provides a communication method. The method is performed by a second device. Alternatively, the method is performed by a part of components (for example, a processor, a chip, or a chip system) in a second device. Alternatively, the method may be implemented by a logical module or software that can implement all or a part of functions of a second device. In the second aspect and a possible embodiment of the second aspect, an example in which the method is performed by the second device is used for description. The second device may be a terminal device or a network device. In the method, the second device determines K pieces of first information, where the K pieces of first information respectively indicate channel characteristic information between K first devices and the second device, the first information is obtained by a first neural network by processing channel information of the first device, and K is an integer greater than or equal to 1. The second device communicates with a part or all of the K first devices based on the K pieces of first information.

According to the foregoing solution, the K pieces of first information determined by the second device respectively indicate the channel characteristic information between the K first devices and the second device, and the first information is obtained by the first neural network by processing the channel information of the first device. In other words, the channel characteristic information for wireless policy optimization may be obtained through neural network processing. Subsequently, the second device can implement wireless policy optimization based on the first information. Therefore, determining the channel characteristic information by using a neural network can improve processing efficiency and reduce a processing delay in a wireless policy optimization process, to improve communication efficiency.

It should be understood that: that the second device communicates with the part or all of the K first devices based on the K pieces of first information may be understood as follows: the second device receives signals of the part or all of the K first devices based on the K pieces of first information, and/or the second device sends signals to the part or all of the K first devices based on the K pieces of first information.

It should be understood that because a network resource is limited, in an implementation process in which the second device communicates with the part or all of the K first devices based on the K pieces of first information, when a current network resource is less than a resource used to carry the signals of the K first devices, the second device may send signals to or receive signals from the part of the K first devices; or when a current network resource is greater than or equal to a resource used to carry the signals of the K first devices, the second device may send signals to or receive signals from the K first devices.

Optionally, the channel characteristic information indicated by the first information may include a channel eigenvalue and/or a channel eigenvector. Alternatively, the channel characteristic information indicated by the first information may include other information indicating a channel characteristic. The channel eigenvalue and/or the channel eigenvector may alternatively be other names, for example, a channel characteristic parameter.

In a possible embodiment of the second aspect, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the first information.

According to the foregoing solution, the first neural network may include the first module used to perform RRF processing, the second module used to perform LRA processing, and the third module used to perform SVD processing. In other words, the first information is obtained by sequentially performing RRF processing, LRA processing, and SVD processing on the channel information of the first device, to provide an implementation of neural network processing.

In a possible embodiment of the second aspect, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

According to the foregoing solution, the matrix dimension of the matrix representation of the channel information of the first device is m×n, the matrix dimension of the matrix representation of the LRA result used by the third module in the first neural network to perform SVD processing is l×n, and the value of lis less than that of m. Therefore, compared with a process of performing SVD on the channel information in an EZF manner, to obtain the channel characteristic information, in the foregoing process of obtaining the LRA result through LRA processing and performing SVD processing on the LRA result, because complexity of performing SVD on the LRA result is less than that of performing SVD on the channel information, the processing efficiency can be further improved, and the processing delay can be further reduced.

In a possible embodiment of the second aspect, the first module includes a first submodule, a second submodule, and a third submodule. The first submodule is used to perform data preprocessing on the channel information of the first device based on a preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

According to the foregoing solution, in a process in which the first module in the first neural network performs RRF processing on the channel information of the first device to obtain the RRF result, a neural network processing process may be affected by using the preprocessing parameter and the oversampling parameter, and the RRF result is determined by sequentially performing processing by using the first submodule, the second submodule, and the third submodule in the first module.

Optionally, in some embodiments, a performance-complexity trade-off can be implemented by adjusting the preprocessing parameter and/or the oversampling parameter (for example, parameter tuning), to adapt to different performance requirements or complexity requirements.

In a possible embodiment of the second aspect, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

According to the foregoing solution, when the second submodule in the first neural network performs randomized neural network processing on the preprocessing result based on the oversampling parameter, to obtain the randomized neural network processing result, performance and complexity of the second submodule may be adjusted by adjusting a value of T, to improve flexibility of implementing the solution, to adapt to different performance requirements or complexity requirements.

In a possible embodiment of the second aspect, that the first information is obtained by the first neural network by processing the channel information of the first device includes: the first information is obtained by the first neural network by processing the channel information of the first device based on a first parameter, where the first parameter includes the oversampling parameter and/or the preprocessing parameter.

According to the foregoing solution, the first information indicating the channel characteristic information between the first device and the second device may be obtained by processing the channel information of the first device based on the first parameter. Therefore, the performance-complexity trade-off can be implemented by adjusting the first parameter (for example, parameter tuning), to adapt to different performance requirements or complexity requirements.

In a possible embodiment of the second aspect, the method further includes: the second device receives indication information indicating the oversampling parameter and/or the preprocessing parameter.

According to the foregoing solution, after receiving the indication information indicating the oversampling parameter and/or the preprocessing parameter, the second device may determine the first information based on the indication information. In other words, the foregoing solution may be applicable to an implementation scenario in which another device (for example, the first device) determines/indicates the oversampling parameter and/or the preprocessing parameter. Therefore, implementation complexity of the second device can be reduced, and the second device can determine a performance and/or complexity configuration of the first device based on the indication information.

In a possible embodiment of the second aspect, the method further includes: the second device sends indication information indicating the oversampling parameter and/or the preprocessing parameter.

According to the foregoing solution, when the oversampling parameter and/or the preprocessing parameter are/is preconfigured on the second device, the second device may further send, to another device (for example, the first device), the indication information indicating the oversampling parameter and/or the preprocessing parameter, so that the second device can flexibly configure performance and/or complexity of the K pieces of first information obtained by the K first devices.

In a possible embodiment of the second aspect, that the second device determines the K pieces of first information includes: the second device receives the K pieces of first information.

According to the foregoing solution, the second device may determine the K pieces of first information in a manner of receiving the K pieces of first information, so that the foregoing solution may be applied to a scenario in which a neural network is configured on the first device. In other words, for the second device, the second device may not locally obtain the K pieces of first information through neural network processing. Therefore, the implementation complexity of the second device can be reduced.

In a possible embodiment of the second aspect, that the second device determines the K pieces of first information includes: the second device determines the K pieces of first information based on the channel information between the K first devices and the second device.

According to the foregoing solution, the second device may locally determine the K pieces of first information by using the channel information between the K first devices and the second device, so that the foregoing solution may be applied to a scenario in which a neural network is configured on the second device. In other words, for the second device, the second device may locally obtain the K pieces of first information through neural network processing, so that signaling overheads can be reduced, and implementation complexity of the first device can be reduced.

In a possible embodiment of the second aspect, the K pieces of first information are used to determine communication parameters of the K first devices. That the second device communicates with the part or all of the K first devices based on the K pieces of first information includes: the second device communicates with the part or all of the K first devices based on the communication parameters of the K first devices.

According to the foregoing solution, the K pieces of first information determined by the second device are used to determine the communication parameters of the K first devices, so that the second device can communicate with the part or all of the K first devices based on the communication parameters of the K first devices.

In a possible embodiment of the second aspect, that the K pieces of first information are used to determine the communication parameters of the K first devices includes: equivalent channel information determined based on the K pieces of first information is used as an input of a second neural network, and is processed by the second neural network to obtain the communication parameters of the K first devices. The equivalent channel information indicates an equivalent channel obtained based on the channel information of the K first devices and a quantity of spatial streams of the K first devices.

According to the foregoing solution, in a process in which the second device determines the communication parameters of the K first devices based on the K pieces of first information, the second device may obtain the communication parameters based on processing of the second neural network and the equivalent channel information determined based on the K pieces of first information. Therefore, determining the communication parameter by using the neural network can improve the processing efficiency and reduce the processing delay.

In a possible embodiment of the second aspect, that the K pieces of first information are used to determine the communication parameters of the K first devices includes: the K pieces of first information are used as an input of a second neural network, and are processed by the second neural network to obtain the communication parameters of the K first devices.

According to the foregoing solution, in a process in which the second device determines the communication parameters of the K first devices based on the K pieces of first information, the second device may obtain the communication parameters based on the K pieces of first information and processing of the second neural network. Therefore, determining the communication parameter by using the neural network can improve the processing efficiency and reduce the processing delay.

In a possible embodiment of the second aspect, the communication parameters of the K first devices include precoding information of the K first devices.

Optionally, the communication parameters of the K first devices may include one or more of device selection and scheduling information, and MIMO detection and demodulation information.

According to the foregoing solution, the communication parameters of the K first devices determined by the second device based on the K pieces of first information may include the precoding information of the K first devices, so that the foregoing solution can be used to resolve a precoding solution problem in wireless policy optimization.

Optionally, when a value of K is greater than 1, the foregoing solution can resolve the precoding solution problem in wireless policy optimization in a multi-user multiple-input multiple-output (MU-MIMO) scenario.

A third aspect of embodiments provides a communication method. The method is performed by a first device. Alternatively, the method is performed by a part of components (for example, a processor, a chip, or a chip system) in a first device. Alternatively, the method may be implemented by a logical module or software that can implement all or a part of functions of a first device. In the third aspect and a possible embodiment of the third aspect, an example in which the method is performed by the first device is used for description. The first device may be a terminal device or a network device. In the method, the first device determines a first parameter, where the first parameter is used by a first neural network to process channel information of the first device to obtain channel characteristic information. The first device sends indication information indicating the first parameter.

According to the foregoing solution, the indication information sent by the first device indicates the first parameter, and the first parameter is used by the first neural network to process the channel information of the first device to obtain the channel characteristic information. In other words, after receiving the indication information, a receiver of the first information may obtain, based on the first parameter through neural network processing, the channel characteristic information for wireless policy optimization. Therefore, determining the channel characteristic information by using a neural network can improve processing efficiency and reduce a processing delay in a wireless policy optimization process, to improve communication efficiency.

Optionally, the channel characteristic information may include a channel eigenvalue and/or a channel eigenvector. Alternatively, the channel characteristic information may include other information indicating a channel characteristic. The channel eigenvalue and/or the channel eigenvector may alternatively be other names, for example, a channel characteristic parameter.

In a possible embodiment of the third aspect, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the channel characteristic information.

According to the foregoing solution, the first neural network may include the first module used to perform RRF processing, the second module used to perform LRA processing, and the third module used to perform SVD processing. In other words, the channel characteristic information is obtained by sequentially performing RRF processing, LRA processing, and SVD processing on the channel information of the first device, to provide an implementation of neural network processing.

In a possible embodiment of the third aspect, a matrix dimension of a matrix representation of the channel information of the first device is m×n, a matrix dimension of a matrix representation of the LRA result is l×n, m is a quantity of antenna ports of a second device, n is a quantity of antenna ports of the first device, and l is an oversampling parameter. A value of l is less than that of m.

According to the foregoing solution, the matrix dimension of the matrix representation of the channel information of the first device is m×n, the matrix dimension of the matrix representation of the LRA result used by the third module in the first neural network to perform SVD processing is Ix n, and the value of lis less than that of m. Therefore, compared with a process of performing SVD on the channel information in an EZF manner, to obtain the channel characteristic information, in the foregoing process of obtaining the LRA result through LRA processing and performing SVD processing on the LRA result, because complexity of performing SVD on the LRA result is less than that of performing SVD on the channel information, the processing efficiency can be further improved, and the processing delay can be further reduced.

In a possible embodiment of the third aspect, the first parameter includes the oversampling parameter and/or a preprocessing parameter, and the first module includes a first submodule, a second submodule, and a third submodule. The first submodule is used to perform data preprocessing on the channel information of the first device based on the preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

According to the foregoing solution, in a process in which the first module in the first neural network performs RRF processing on the channel information of the first device to obtain the RRF result, a neural network processing process may be affected by using the preprocessing parameter and the oversampling parameter, and the RRF result is determined by sequentially performing processing by using the first submodule, the second submodule, and the third submodule in the first module.

Optionally, in some embodiments, a performance-complexity trade-off can be implemented by adjusting the preprocessing parameter and/or the oversampling parameter (for example, parameter tuning), to adapt to different performance requirements or complexity requirements.

In a possible embodiment of the third aspect, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

According to the foregoing solution, when the second submodule in the first neural network performs randomized neural network processing on the preprocessing result based on the oversampling parameter, to obtain the randomized neural network processing result, performance and complexity of the second submodule may be adjusted by adjusting a value of T, to improve flexibility of implementing the solution, to adapt to different performance requirements or complexity requirements.

In a possible embodiment of the third aspect, the channel characteristic information of the first device is used to determine a communication parameter of the first device.

According to the foregoing solution, the channel characteristic information of the first device may be used to determine the communication parameter of the first device, so that the first device or the second device can subsequently implement wireless policy optimization based on the communication parameter of the first device.

In a possible embodiment of the third aspect, that the channel characteristic information is used to determine the communication parameter of the first device includes: equivalent channel information determined based on the channel characteristic information is used as an input of a second neural network, and is processed by the second neural network to obtain the communication parameter of the first device. The equivalent channel information indicates an equivalent channel obtained based on the channel information of the first device and a quantity of spatial streams of the first device.

According to the foregoing solution, in a process of determining the communication parameter by using the channel characteristic information, the communication parameter may be obtained based on processing of the second neural network and the equivalent channel information determined based on the channel characteristic information. Therefore, determining the communication parameter by using a neural network can improve the processing efficiency and reduce the processing delay.

In a possible embodiment of the third aspect, that the channel characteristic information is used to determine the communication parameter of the first device includes: the channel characteristic information is used as an input of a second neural network, and is processed by the second neural network to obtain the communication parameter of the first device.

According to the foregoing solution, in a process of determining the communication parameter by using the channel characteristic information, the communication parameter may be obtained based on the channel characteristic information and processing of the second neural network. Therefore, determining the communication parameter by using a neural network can improve the processing efficiency and reduce the processing delay.

In a possible embodiment of the third aspect, the communication parameter of the first device includes precoding information of the first device.

According to the foregoing solution, the communication parameter determined by using the channel characteristic information may include the precoding information, so that the foregoing solution can be used to resolve a precoding solution problem in wireless policy optimization.

A fourth aspect of embodiments provides a communication method. The method is performed by a second device. Alternatively, the method is performed by a part of components (for example, a processor, a chip, or a chip system) in a second device. Alternatively, the method may be implemented by a logical module or software that can implement all or a part of functions of a second device. In the fourth aspect and a possible embodiment of the fourth aspect, an example in which the method is performed by the second device is used for description. The second device may be a terminal device or a network device. In the method, the second device receives indication information indicating a first parameter. The second device processes channel information of a first device based on the first parameter by using a first neural network, to obtain channel characteristic information, where the channel characteristic information includes a channel eigenvalue and/or a channel eigenvector.

According to the foregoing solution, the indication information received by the second device indicates the first parameter, and the first parameter is used by the first neural network to process the channel information of the first device to obtain the channel characteristic information. In other words, after receiving the indication information, the second device may obtain, based on the first parameter through neural network processing, the channel characteristic information for wireless policy optimization. Therefore, determining the channel characteristic information by using a neural network can improve processing efficiency and reduce a processing delay in a wireless policy optimization process, to improve communication efficiency.

Optionally, the channel characteristic information may include the channel eigenvalue and/or the channel eigenvector. Alternatively, the channel characteristic information may include other information indicating a channel characteristic. The channel eigenvalue and/or the channel eigenvector may alternatively be other names, for example, a channel characteristic parameter.

In a possible embodiment of the fourth aspect, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the channel characteristic information.

According to the foregoing solution, the first neural network may include the first module used to perform RRF processing, the second module used to perform LRA processing, and the third module used to perform SVD processing. In other words, the first information is obtained by sequentially performing RRF processing, LRA processing, and SVD processing on the channel information of the first device, to provide an embodiment of neural network processing.

In a possible embodiment of the fourth aspect, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

According to the foregoing solution, the matrix dimension of the matrix representation of the channel information of the first device is m×n, the matrix dimension of the matrix representation of the LRA result used by the third module in the first neural network to perform SVD processing is l×n, and the value of l is less than that of m. Therefore, compared with a process of performing SVD on the channel information in an EZF manner, to obtain the channel characteristic information, in the foregoing process of obtaining the LRA result through LRA processing and performing SVD processing on the LRA result, because complexity of performing SVD on the LRA result is less than that of performing SVD on the channel information, the processing efficiency can be further improved, and the processing delay can be further reduced.

In a possible embodiment of the fourth aspect, the first parameter includes the oversampling parameter and/or a preprocessing parameter, and the first module includes a first submodule, a second submodule, and a third submodule. The first submodule is used to perform data preprocessing on the channel information of the first device based on the preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

According to the foregoing solution, in a process in which the first module in the first neural network performs RRF processing on the channel information of the first device to obtain the RRF result, a neural network processing process may be affected by using the preprocessing parameter and the oversampling parameter, and the RRF result is determined by sequentially performing processing by using the first submodule, the second submodule, and the third submodule in the first module.

Optionally, in some embodiments, a performance-complexity trade-off can be implemented by adjusting the preprocessing parameter and/or the oversampling parameter (for example, parameter tuning), to adapt to different performance requirements or complexity requirements.

In a possible embodiment of the fourth aspect, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

According to the foregoing solution, when the second submodule in the first neural network performs randomized neural network processing on the preprocessing result based on the oversampling parameter, to obtain the randomized neural network processing result, performance and complexity of the second submodule may be adjusted by adjusting a value of T, to improve flexibility of implementing the solution, to adapt to different performance requirements or complexity requirements.

In a possible embodiment of the fourth aspect, the channel characteristic information of the first device is used to determine a communication parameter of the first device.

According to the foregoing solution, the channel characteristic information of the first device may be used to determine the communication parameter of the first device, so that the first device or the second device can subsequently implement wireless policy optimization based on the communication parameter of the first device.

In a possible embodiment of the fourth aspect, that the channel characteristic information is used to determine the communication parameter of the first device includes: equivalent channel information determined based on the channel characteristic information is used as an input of a second neural network, and is processed by the second neural network to obtain the communication parameter of the first device. The equivalent channel information indicates an equivalent channel obtained based on the channel information of the first device and a quantity of spatial streams of the first device.

According to the foregoing solution, in a process of determining the communication parameter by using the channel characteristic information, the communication parameter may be obtained based on processing of the second neural network and the equivalent channel information determined based on the channel characteristic information. Therefore, determining the communication parameter by using a neural network can improve the processing efficiency and reduce the processing delay.

In a possible embodiment of the fourth aspect, that the channel characteristic information is used to determine the communication parameter of the first device includes: the channel characteristic information is used as an input of a second neural network, and is processed by the second neural network to obtain the communication parameter of the first device.

According to the foregoing solution, in a process of determining the communication parameter by using the channel characteristic information, the communication parameter may be obtained based on the channel characteristic information and processing of the second neural network. Therefore, determining the communication parameter by using a neural network can improve the processing efficiency and reduce the processing delay.

In a possible embodiment of the fourth aspect, the communication parameter of the first device includes precoding information of the first device.

According to the foregoing solution, the communication parameter determined by using the channel characteristic information may include the precoding information, so that the foregoing solution can be used to resolve a precoding solution problem in wireless policy optimization.

A fifth aspect of embodiments provides a communication apparatus. The apparatus is a first device. Alternatively, the apparatus is a part of components (for example, a processor, a chip, or a chip system) in a first device. Alternatively, the apparatus may be a logical module or software that can implement all or a part of functions of a first device. In the fifth aspect and a possible embodiment of the fifth aspect, an example in which the communication apparatus is the first device is used for description. The first device may be a terminal device or a network device.

The apparatus includes a processing unit and a transceiver unit. The processing unit is configured to determine first information, where the first information indicates channel characteristic information between the first device and a second device, the channel characteristic information includes a channel eigenvalue and/or a channel eigenvector, and the first information is obtained by a first neural network by processing channel information of the first device. The transceiver unit is configured to send the first information.

In a possible embodiment of the fifth aspect, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the first information.

In a possible embodiment of the fifth aspect, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

In a possible embodiment of the fifth aspect, the first module includes a first submodule, a second submodule, and a third submodule. The first submodule is used to perform data preprocessing on the channel information of the first device based on a preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

In a possible embodiment of the fifth aspect, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

In a possible embodiment of the fifth aspect, that the first information is obtained by the first neural network by processing the channel information of the first device includes: the first information is obtained by the first neural network by processing the channel information of the first device based on a first parameter, where the first parameter includes the oversampling parameter and/or the preprocessing parameter.

In a possible embodiment of the fifth aspect, the transceiver unit is further configured to receive indication information indicating the oversampling parameter and/or the preprocessing parameter.

In a possible embodiment of the fifth aspect, the transceiver unit is further configured to send indication information indicating the oversampling parameter and/or the preprocessing parameter.

In the fifth aspect of embodiments, the component modules of the communication apparatus may be further configured to: perform the steps or operations performed in the possible embodiments of the first aspect, and achieve corresponding effects. For details, refer to the first aspect. Details are not described herein again.

A sixth aspect of embodiments provides a communication apparatus. The apparatus is a second device. Alternatively, the apparatus is a part of components (for example, a processor, a chip, or a chip system) in a second device. Alternatively, the apparatus may be a logical module or software that can implement all or a part of functions of a second device. In the sixth aspect and a possible embodiment of the sixth aspect, an example in which the communication apparatus is the second device is used for description. The second device may be a terminal device or a network device.

The apparatus includes a processing unit and a transceiver unit. The processing unit is configured to determine K pieces of first information, where the K pieces of first information respectively indicate channel characteristic information between K first devices and the second device, the channel characteristic information includes a channel eigenvalue and/or a channel eigenvector, the first information is obtained by a first neural network by processing channel information of the first device, and K is an integer greater than or equal to 1. The transceiver unit is configured to communicate with a part or all of the K first devices based on the K pieces of first information.

In a possible embodiment of the sixth aspect, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the first information.

In a possible embodiment of the sixth aspect, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

In a possible embodiment of the sixth aspect, the first module includes a first submodule, a second submodule, and a third submodule. The first submodule is used to perform data preprocessing on the channel information of the first device based on a preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

In a possible embodiment of the sixth aspect, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

In a possible embodiment of the sixth aspect, that the first information is obtained by the first neural network by processing the channel information of the first device includes: the first information is obtained by the first neural network by processing the channel information of the first device based on a first parameter, where the first parameter includes the oversampling parameter and/or the preprocessing parameter.

In a possible embodiment of the sixth aspect, the transceiver unit is further configured to receive indication information indicating the oversampling parameter and/or the preprocessing parameter.

In a possible embodiment of the sixth aspect, the transceiver unit is further configured to send indication information indicating the oversampling parameter and/or the preprocessing parameter.

In a possible embodiment of the sixth aspect, the processing unit is configured to receive the K pieces of first information via the transceiver unit.

In a possible embodiment of the sixth aspect, the processing unit is configured to determine the K pieces of first information based on the channel information between the K first devices and the second device.

In a possible embodiment of the sixth aspect, the K pieces of first information are used to determine communication parameters of the K first devices. The transceiver unit is configured to communicate with the part or all of the K first devices based on the communication parameters of the K first devices.

In a possible embodiment of the sixth aspect, that the K pieces of first information are used to determine the communication parameters of the K first devices includes: equivalent channel information determined based on the K pieces of first information is used as an input of a second neural network, and is processed by the second neural network to obtain the communication parameters of the K first devices. The equivalent channel information indicates an equivalent channel obtained based on the channel information of the K first devices and a quantity of spatial streams of the K first devices.

In a possible embodiment of the sixth aspect, that the K pieces of first information are used to determine the communication parameters of the K first devices includes: the K pieces of first information are used as an input of a second neural network, and are processed by the second neural network to obtain the communication parameters of the K first devices.

In a possible embodiment of the sixth aspect, the communication parameters of the K first devices include precoding information of the K first devices.

Optionally, the communication parameters of the K first devices may include one or more of device selection and scheduling information, and MIMO detection and demodulation information.

In the sixth aspect of embodiments, the component modules of the communication apparatus may be further configured to: perform the steps or operations performed in the possible embodiments of the second aspect, and achieve corresponding effects. For details, refer to the second aspect. Details are not described herein again.

A seventh aspect of embodiments provides a communication apparatus. The apparatus is a first device. Alternatively, the apparatus is a part of components (for example, a processor, a chip, or a chip system) in a first device. Alternatively, the apparatus may be a logical module or software that can implement all or a part of functions of a first device. In the seventh aspect and a possible embodiment of the seventh aspect, an example in which the communication apparatus is the first device is used for description. The first device may be a terminal device or a network device.

The apparatus includes a processing unit and a transceiver unit. The processing unit is configured to determine a first parameter, where the first parameter is used by a first neural network to process channel information of the first device to obtain channel characteristic information, and the channel characteristic information includes a channel eigenvalue and/or a channel eigenvector. The transceiver unit is configured to send indication information indicating the first parameter.

In a possible embodiment of the seventh aspect, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the channel characteristic information.

In a possible embodiment of the seventh aspect, a matrix dimension of a matrix representation of the channel information of the first device is m×n, a matrix dimension of a matrix representation of the LRA result is l×n, m is a quantity of antenna ports of a second device, n is a quantity of antenna ports of the first device, and l is an oversampling parameter. A value of l is less than that of m.

In a possible embodiment of the seventh aspect, the first parameter includes the oversampling parameter and/or a preprocessing parameter, and the first module includes a first submodule, a second submodule, and a third submodule. The first submodule is used to perform data preprocessing on the channel information of the first device based on the preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

In a possible embodiment of the seventh aspect, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

In a possible embodiment of the seventh aspect, the channel characteristic information of the first device is used to determine a communication parameter of the first device.

In a possible embodiment of the seventh aspect, that the channel characteristic information is used to determine the communication parameter of the first device includes: equivalent channel information determined based on the channel characteristic information is used as an input of a second neural network, and is processed by the second neural network to obtain the communication parameter of the first device. The equivalent channel information indicates an equivalent channel obtained based on the channel information of the first device and a quantity of spatial streams of the first device.

In a possible embodiment of the seventh aspect, that the channel characteristic information is used to determine the communication parameter of the first device includes: the channel characteristic information is used as an input of a second neural network, and is processed by the second neural network to obtain the communication parameter of the first device.

In a possible embodiment of the seventh aspect, the communication parameter of the first device includes precoding information of the first device.

In the seventh aspect of embodiments, the component modules of the communication apparatus may be further configured to: perform the steps or operations performed in the possible embodiments of the third aspect, and achieve corresponding effects. For details, refer to the third aspect. Details are not described herein again.

An eighth aspect of embodiments provides a communication apparatus. The apparatus is a second device. Alternatively, the apparatus is a part of components (for example, a processor, a chip, or a chip system) in a second device. Alternatively, the apparatus may be a logical module or software that can implement all or a part of functions of a second device. In the eighth aspect and a possible embodiment of the eighth aspect, an example in which the communication apparatus is the second device is used for description. The second device may be a terminal device or a network device.

The apparatus includes a processing unit and a transceiver unit. The transceiver unit is configured to receive indication information indicating a first parameter. The processing unit is configured to process channel information of a first device based on the first parameter by using a first neural network, to obtain channel characteristic information, where the channel characteristic information includes a channel eigenvalue and/or a channel eigenvector.

In a possible embodiment of the eighth aspect, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the channel characteristic information.

In a possible embodiment of the eighth aspect, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

In a possible embodiment of the eighth aspect, the first parameter includes the oversampling parameter and/or a preprocessing parameter, and the first module includes a first submodule, a second submodule, and a third submodule. The first submodule is used to perform data preprocessing on the channel information of the first device based on the preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

In a possible embodiment of the eighth aspect, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

In a possible embodiment of the eighth aspect, the channel characteristic information of the first device is used to determine a communication parameter of the first device.

In a possible embodiment of the eighth aspect, that the channel characteristic information is used to determine the communication parameter of the first device includes: equivalent channel information determined based on the channel characteristic information is used as an input of a second neural network, and is processed by the second neural network to obtain the communication parameter of the first device. The equivalent channel information indicates an equivalent channel obtained based on the channel information of the first device and a quantity of spatial streams of the first device.

In a possible embodiment of the eighth aspect, that the channel characteristic information is used to determine the communication parameter of the first device includes: the channel characteristic information is used as an input of a second neural network, and is processed by the second neural network to obtain the communication parameter of the first device.

In a possible embodiment of the eighth aspect, the communication parameter of the first device includes precoding information of the first device.

In the eighth aspect of embodiments, the component modules of the communication apparatus may be further configured to: perform the steps or operations performed in the possible embodiments of the fourth aspect, and achieve corresponding effects. For details, refer to the fourth aspect. Details are not described herein again.

A ninth aspect of embodiments provides a communication apparatus, including at least one processor. The at least one processor is coupled to a memory. The memory is configured to store a program or instructions. The at least one processor is configured to execute the program or the instructions, so that the apparatus implements the method according to any one of the first aspect or the possible embodiments of the first aspect.

A tenth aspect of embodiments provides a communication apparatus, including at least one processor. The at least one processor is coupled to a memory. The memory is configured to store a program or instructions. The at least one processor is configured to execute the program or the instructions, so that the apparatus implements the method according to any one of the second aspect or the possible embodiments of the second aspect.

An eleventh aspect of embodiments provides a communication apparatus, including at least one processor. The at least one processor is coupled to a memory. The memory is configured to store a program or instructions. The at least one processor is configured to execute the program or the instructions, so that the apparatus implements the method according to any one of the third aspect or the possible embodiments of the third aspect.

A twelfth aspect of embodiments provides a communication apparatus, including at least one processor. The at least one processor is coupled to a memory. The memory is configured to store a program or instructions. The at least one processor is configured to execute the program or the instructions, so that the apparatus implements the method according to any one of the fourth aspect or the possible embodiments of the fourth aspect.

A thirteenth aspect of embodiments provides a communication apparatus, including at least one logic circuit and an input/output interface. The logic circuit is configured to perform the method according to any one of the first aspect or the possible embodiments of the first aspect.

A fourteenth aspect of embodiments provides a communication apparatus, including at least one logic circuit and an input/output interface. The logic circuit is configured to perform the method according to any one of the second aspect or the possible embodiments of the second aspect.

A fifteenth aspect of embodiments provides a communication apparatus, including at least one logic circuit and an input/output interface. The logic circuit is configured to perform the method according to any one of the third aspect or the possible embodiments of the third aspect.

A sixteenth aspect of embodiments provides a communication apparatus, including at least one logic circuit and an input/output interface. The logic circuit is configured to perform the method according to any one of the fourth aspect or the possible embodiments of the fourth aspect.

A seventeenth aspect of embodiments provides a non-transitory computer-readable storage medium. The storage medium is configured to store one or more computer-executable instructions. When the computer-executable instructions are executed by a processor, the processor performs the method according to any possible embodiment of any one of the first aspect to the fourth aspect.

An eighteenth aspect of embodiments provides a computer program product (or referred to as a computer program). When the computer program product is executed by a processor, the processor performs the method according to any possible embodiment of any one of the first aspect to the fourth aspect.

A nineteenth aspect of embodiments provides a chip system. The chip system includes at least one processor, configured to support a communication apparatus in implementing a function in any possible embodiment of any one of the first aspect to the fourth aspect.

In a possible embodiment, the chip system may further include a memory. The memory is configured to store program instructions and data that are necessary for the first communication apparatus. The chip system may include a chip, or may include a chip and another discrete component. Optionally, the chip system further includes an interface circuit, and the interface circuit provides program instructions and/or data for the at least one processor.

A twentieth aspect of embodiments provides a communication system. The communication system includes the communication apparatus according to the fifth aspect and the communication apparatus according to the sixth aspect. Additionally/Alternatively, the communication system includes the communication apparatus according to the seventh aspect and the communication apparatus according to the eighth aspect. Additionally/Alternatively, the communication system includes the communication apparatus according to the ninth aspect and the communication apparatus according to the tenth aspect. Additionally/Alternatively, the communication system includes the communication apparatus according to the eleventh aspect and the communication apparatus according to the twelfth aspect. Additionally/Alternatively, the communication system includes the communication apparatus according to the thirteenth aspect and the communication apparatus according to the fourteenth aspect.

Additionally/Alternatively, the communication system includes the communication apparatus according to the fifteenth aspect and the communication apparatus according to the sixteenth aspect.

For effects brought by any design manner in the fifth aspect to the twentieth aspect, refer to the effects brought by different design manners in the first aspect to the fourth aspect. Details are not described herein again.

### BRIEF DESCRIPTION OF DRAWINGS

FIG. 1a is a diagram of a communication system according to the embodiments.

FIG. 1b is another diagram of a communication system according to the embodiments;

FIG. 1c is another diagram of a communication system according to the embodiments;

FIG. 2a is a diagram of an AI processing process according to the embodiments;

FIG. 2b is another diagram of an AI processing process according to the embodiments;

FIG. 2c is another diagram of an AI processing process according to the embodiments;

FIG. 2d is another diagram of an AI processing process according to the embodiments;

FIG. 3 is a diagram of interaction in a communication method according to the embodiments;

FIG. 4a is a diagram of a neural network processing process according to the embodiments;

FIG. 4b is another diagram of a neural network processing process according to the embodiments;

FIG. 4c is another diagram of a neural network processing process according to the embodiments;

FIG. 5 is a diagram of a neural network processing process according to the embodiments;

FIG. 6a is another diagram of a neural network processing process according to the embodiments;

FIG. 6b is another diagram of a neural network processing process according to the embodiments;

FIG. 7 is another diagram of interaction in a communication method according to the embodiments;

FIG. 8 is a diagram of a communication apparatus according to the embodiments;

FIG. 9 is another diagram of a communication apparatus according to the embodiments;

FIG. 10 is another diagram of a communication apparatus according to the embodiments; and

FIG. 11 is another diagram of a communication apparatus according to the embodiments.

### DETAILED DESCRIPTION OF EMBODIMENTS

For ease of understanding by a person skilled in the art, some terms in embodiments are described first.

(1) Terminal device: may be a wireless terminal device that can receive scheduling and indication information of a network device. The wireless terminal device may be a device providing voice and/or data connectivity for a user, a handheld device having a wireless connection function, or another processing device connected to a wireless modem.

The terminal device may communicate with one or more core networks or an internet through a RAN. The terminal device may be a mobile terminal device such as a mobile phone (or referred to as a “cellular” phone or a mobile phone), a computer, or a data card. For example, the terminal device may be a portable, pocket-sized, handheld, computer built-in, or vehicle-mounted mobile apparatus that exchanges voice and/or data with the radio access network. For example, the terminal device may be a device such as a personal communication service (PCS) phone, a cordless phone, a session initiation protocol (SIP) phone, a wireless local loop (WLL) station, a personal digital assistant (PDA), a tablet computer (Pad), or a computer having a wireless transceiver function. The wireless terminal device may also be referred to as a system, a subscriber unit, a subscriber station, a mobile station (MS), a remote station, an access point (AP), a remote terminal device, an access terminal device (access terminal), a user terminal device (user terminal), a user agent, a subscriber station (SS), customer premises equipment (CPE), a terminal, user equipment (UE), a mobile terminal (MT), or the like.

As an example instead of a limitation, in embodiments, the terminal device may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that is directly worn on a body or integrated into clothes or an accessory of the user. The wearable device is not only a hardware device, but also implements a powerful function through software support, data exchange, and cloud interaction. In a broad sense, the wearable intelligent device includes a full-featured and large-sized device that can implement all or a part of functions without depending on a smartphone, for example, a smart watch or smart glasses, and includes a device that is dedicated to only one type of application function and may collaboratively work with another device such as a smartphone, for example, various smart bands, smart helmets, or smart jewelry for monitoring physical signs.

The terminal may alternatively be an uncrewed aerial vehicle, a robot, a terminal in device-to-device (D2D) communication, a terminal in vehicle-to-everything (V2X), a virtual reality (VR) terminal device, an augmented reality (AR) terminal device, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home, or the like.

In addition, the terminal device may be a terminal device in an evolved communication system (for example, a 6th generation (6G) communication system) after a 5th generation (5G) communication system, a terminal device in a future evolved public land mobile network (PLMN), or the like. For example, a 6G network may further extend a form and a function of a 5G communication terminal, and a 6G terminal includes but is not limited to a vehicle, a cellular network terminal (integrating a function of a satellite terminal), an uncrewed aerial vehicle, and an Internet of Things (IoT) device.

In embodiments, the terminal device may further obtain an AI service provided by a network device. Optionally, the terminal device may further have an AI processing capability.

(2) Network device: may be a device in a wireless network. For example, the network device may be a RAN node (or device) connecting a terminal device to the wireless network, and may also be referred to as a base station. Currently, some examples of the RAN device are: a base station gNB (gNodeB) in a 5G communication system, a transmission reception point (TRP), an evolved NodeB (eNB), a radio network controller (RNC), a NodeB (NB), a home base station (for example, a home evolved NodeB or a home NodeB, HNB), a baseband unit (BBU), or a wireless fidelity (Wi-Fi) access point AP. In addition, in a network structure, the network device may include a central unit (CU) node, a distributed unit (DU) node, or a RAN device including a CU node and a DU node.

The network device may be another apparatus that provides a wireless communication function for the terminal device. A technology and a device form that are used by the network device are not limited. For ease of description, this is not limited herein.

The network device may further include a core network device. For example, the core network device includes network elements such as a mobility management entity (MME), a home subscriber server (HSS), a serving gateway (S-GW), a policy and charging rules function (PCRF), and a public data network gateway (PDN gateway, P-GW) in a 4th generation (4G) network, and an access and mobility management function (AMF), a user plane function (UPF), and a session management function (SMF) in a 5G network. In addition, the core network device may further include another core network device in the 5G network and a next generation network of the 5G network.

In embodiments, the network device may alternatively be a network node having an AI capability, and may provide an AI service for a terminal or another network device, for example, may be an AI node, a computing power node, a RAN node having an AI capability, or a core network element having an AI capability on a network side (an access network or a core network).

In embodiments, an apparatus configured to implement a function of the network device may be the network device, or may be an apparatus, for example, a chip system, that can support the network device in implementing the function. The apparatus may be installed in the network device. In the solutions provided in embodiments, an example in which the apparatus configured to implement the function of the network device is the network device is used to describe the solutions provided in embodiments.

(3) Configuration and preconfiguration: in the embodiments, both the configuration and the preconfiguration are used. The configuration means that a network device/server sends configuration information of some parameters or values of parameters to a terminal by using a message or signaling, so that the terminal determines, based on the values or the information, a communication parameter or a resource for transmission. Similar to the configuration, the preconfiguration may be parameter information or a parameter value negotiated by a network device/server with a terminal device in advance, or may be parameter information or a parameter value used by a base station/network device or a terminal device as specified in a standard protocol, or may be parameter information or a parameter value prestored in a base station/server or a terminal device. This is not limited herein.

Further, these values and parameters may be changed or updated.

(4) Terms “system” and “network” in embodiments may be used interchangeably. “A plurality of” means two or more than two. The term “and/or” describes an association relationship between associated objects, and indicates that three relationships may exist. For example, A and/or B may indicate the following three cases: only A exists, both A and B exist, and only B exists, where A and B may be singular or plural. The character “/” generally indicates an “or” relationship between the associated objects. “At least one of the following items (pieces)” or a similar expression thereof indicates any combination of these items, including a single item (piece) or any combination of a plurality of items (pieces). For example, “at least one of A, B, and C” includes A, B, C, AB, AC, BC, or ABC. In addition, unless otherwise specified, ordinal numbers such as “first” and “second” in embodiments are used to distinguish between a plurality of objects, and are not intended to limit a sequence, a time sequence, priorities, or importance of the plurality of objects.

(5) “Sending” and “receiving” in embodiments represent signal transfer directions. For example, “sending information to XX” may be understood as that a destination end of the information is XX, and may include direct sending through an air interface, or indirect sending through an air interface by another unit or module. “Receiving information from YY” may be understood as that a source end of the information is YY, and may include direct receiving from YY through an air interface, or indirect receiving from YY through an air interface from another unit or module. “Sending” may alternatively be understood as “outputting” of a chip interface, and “receiving” may alternatively be understood as “inputting” of a chip interface.

In other words, sending and receiving may be performed between devices, for example, between a network device and a terminal device; or may be performed inside a device, for example, sending or receiving between components, modules, chips, software modules, or hardware modules inside the device through a bus, a cable, or an interface.

It may be understood that necessary processing such as encoding and modulation may be performed on information between a source end and a destination end of information sending, but the destination end may understand effective information from the source end. Similar descriptions herein may be understood similarly. Details are not described again.

(6) In embodiments, “indication” may include a direct indication and an indirect indication, or may include an explicit indication and an implicit indication. Information indicated by a piece of information (for example, the following indication information) is referred to as to-be-indicated information. In an implementation process, there are many manners of indicating the to-be-indicated information. For example, the manners include but are not limited to: a manner in which the to-be-indicated information, for example, the to-be-indicated information or an index of the to-be-indicated information, may be directly indicated; a manner in which the to-be-indicated information is indirectly indicated by indicating other information, where there is an association relationship between the other information and the to-be-indicated information; and a manner in which only a part of the to-be-indicated information is indicated, and a remaining part of the to-be-indicated information is known or pre-agreed on. For example, information may be indicated by using an arrangement sequence of pieces of information that are pre-agreed on (for example, predefined in a protocol), to reduce indication overheads to some extent. A indication manner is not limited. It may be understood that for a sender of the indication information, the indication information may indicate the to-be-indicated information, and for a receiver of the indication information, the indication information may be for determining the to-be-indicated information.

In the embodiments, for same or similar parts of embodiments, mutual reference may be made between embodiments, unless otherwise specified. In embodiments and methods/designs/implementations in embodiments, unless otherwise specified or logic conflicts occur, terms and/or descriptions between different embodiments and between the methods/designs/implementations in embodiments are consistent and may be mutually referenced. Different embodiments and features in the methods/designs/implementations in embodiments may be combined to form a new embodiment, method, or implementation based on an internal logic relationship thereof. The following embodiments are not intended to limit the scope.

The embodiments may be applied to a long term evolution (LTE) system, a new radio (new radio, NR) system, or an evolved communication system (for example, 6G) after 5G. The communication system includes at least one network device and/or at least one terminal device.

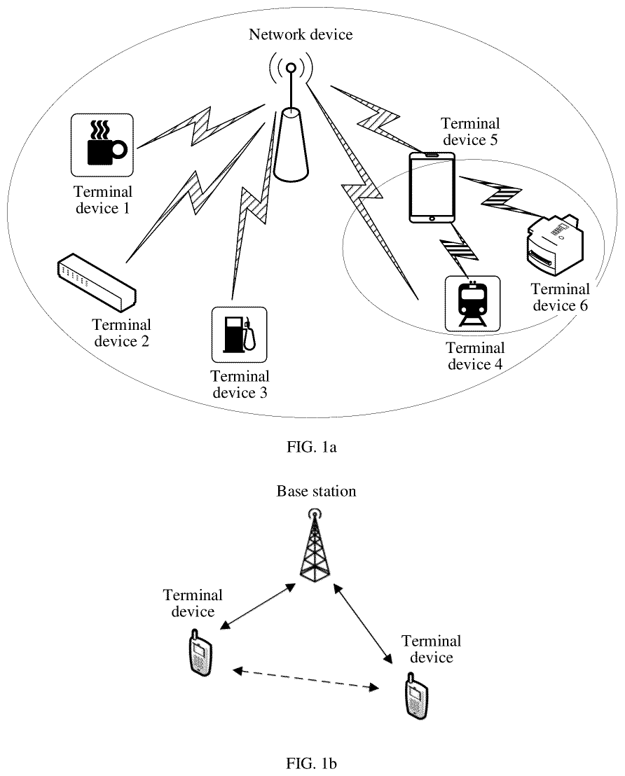

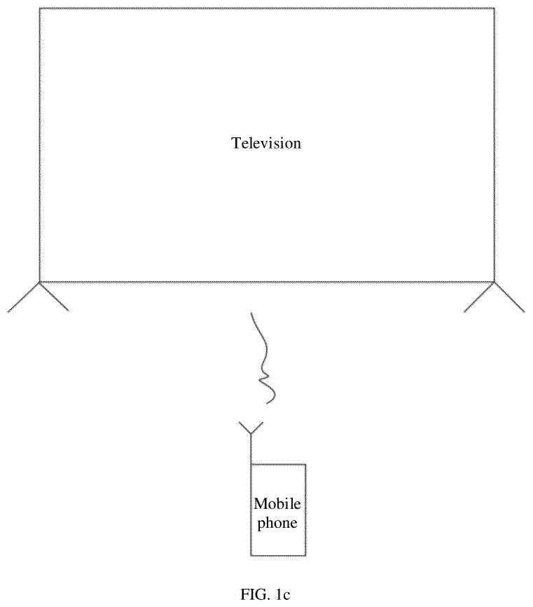

FIG. 1a is a diagram of a communication system according to the embodiments. FIG. 1a shows an example of one network device 101 and six terminal devices. The six terminal devices are a terminal device 1, a terminal device 2, a terminal device 3, a terminal device 4, a terminal device 5, and a terminal device 6. In the example shown in FIG. 1a, an example in which the terminal device l is a smart teacup, the terminal device 2 is a smart air conditioner, the terminal device 3 is a smart fuel dispenser, the terminal device 4 is a transport means, the terminal device 5 is a mobile phone, and the terminal device 6 is a printer is used for description.

As shown in FIG. 1a, an AI configuration information sending entity may be the network device. AI configuration information receiving entities may be the terminal device 1 to the terminal device 6. In this case, the network device and the terminal device 1 to the terminal device 6 form a communication system. In the communication system, the terminal device 1 to the terminal device 6 may send data to the network device, and the network device may receive the data sent by the terminal device 1 to the terminal device 6. In addition, the network device may send configuration information to the terminal device 1 to the terminal device 6.

Optionally, the AI configuration information may include indication information of a node type mentioned below. The data may include model information of an AI model and/or auxiliary information of the AI model mentioned below.

For example, in FIG. 1a, the terminal device 4 to the terminal device 6 may also form a communication system. The terminal device 5 serves as a network device, for example, an AI configuration information sending entity. The terminal device 4 and the terminal device 6 serve as terminal devices, for example, AI configuration information receiving entities. For example, in an internet of vehicles system, the terminal device 5 separately sends AI configuration information to the terminal device 4 and the terminal device 6, and receives data sent by the terminal device 4 and the terminal device 6; and correspondingly, the terminal device 4 and the terminal device 6 receive the AI configuration information sent by the terminal device 5, and send the data to the terminal device 5.

The communication system shown in FIG. 1a is used as an example. In addition to a communication-related service, an AI-related service may be performed between different devices (including between network devices, between a network device and a terminal device, and/or between terminal devices). For example, as shown in FIG. 1b, an example in which a network device is a base station is used. A communication-related service and an AI-related service may be performed between the base station and one or more terminal devices, and the communication-related service and the AI-related service may also be performed between different terminal devices. For another example, as shown in FIG. 1c, an example in which terminal devices include a television and a mobile phone is used. A communication-related service and an AI-related service may also be performed between the television and the mobile phone.

The solutions provided in the embodiments may be applied to a wireless communication system (for example, the system shown in FIG. 1a, FIG. 1b, or FIG. 1c). Wireless policy optimization (for example, resource allocation, channel estimation, and signal detection) is an important issue in wireless communication. Precoding is used as an example. Precoding in the wireless communication system can effectively improve system energy efficiency and spectral efficiency. Although an iterative algorithm has been proposed in related literatures to resolve a non-convex precoding optimization problem, an obtained numerical solution is sensitive to defects (such as channel estimation errors) in some systems. In addition, it is difficult to jointly optimize precoding and other related tasks (such as channel estimation), while separate optimization can find only suboptimal solutions. Another disadvantage of a conventional optimization method is that computational complexity is high when a problem scale is large, which limits application of the method in a network with a real-time requirement.

A precoding solution problem is used as an example. In a possible embodiment, precoding information is determined in an eigen zero forcing (EZF) manner. For example, after obtaining channel information of K (K is an integer greater than 1) terminal devices, a network device whose antenna quantity (or antenna port quantity) is m performs SVD on a matrix

$${H}_{k}^{H} ( {H}_{k}^{H}$$

represents a conjugate transpose matrix of Hₖ) corresponding to channel information Hₖ of a k^{th} (k=1, 2, . . . , K) terminal device in a plurality of terminal devices, for example, the following condition is satisfied:

$${H}_{k}^{H} = {U}_{k} {Σ}_{k} {W}_{k}^{H} = {U}_{k} [ \begin{matrix}\sqrt{{λ}_{k , 1}} & 0 & … & 0 & … & 0 \\ 0 & \sqrt{{λ}_{k , 2}} & … & 0 & … & 0 \\ ⋮ & ⋮ & ⋱ & 0 & … & 0 \\ 0 & 0 & … & \sqrt{{λ}_{k , n}} & … & 0\end{matrix} ] [ \begin{matrix}{w}_{k , 1}^{H} \\ {w}_{k , 2}^{H} \\ ⋮ \\ {w}_{k , m}^{H}\end{matrix} ]$$

Uₖ represents a matrix formed by a left singular vector of the channel information Hₖ of the k^{th} terminal device. Σₖ represents a matrix formed by channel eigenvalues of the k^{th} terminal device. Wₖ represents a matrix formed by channel eigenvectors of the k^{th} terminal device.

$${W}_{k}^{H}$$

represents a conjugate transpose of Wₖ. λ_{k,1}, . . . , λ_{k,n} represent the channel eigenvalues of the k^{th} terminal device. w_{k,1}, w_{k,2}, . . . , w_{k,m} represent the channel eigenvectors of the k^{th} terminal device.

In addition, after obtaining an eigenvalue and an eigenvector of a channel matrix, the network device performs user selection by using a user selection algorithm (for example, a semi-orthogonal user selection algorithm), determines a quantity of flows used by each user, and determines an equivalent channel C based on a user selection result, satisfying:

$$C = {[ \sqrt{{λ}_{1 , 1}} {w}_{1 , 1}^{H} , … , \sqrt{{λ}_{1 , {L}_{1}}} {w}_{1 , {L}_{1}}^{H} , \sqrt{{λ}_{2 , 1}} {w}_{2 , 1}^{H} , … , \sqrt{{λ}_{2 , {L}_{2}}} {w}_{2 , {L}_{2}}^{H} , … , \sqrt{{λ}_{K , 1}} {w}_{K , 1}^{H} , … , \sqrt{{λ}_{K , {L}_{K}}} {w}_{K , {L}_{K}}^{H} ]}^{T}$$

Lₖ is a quantity of spatial streams used by the k^{th} terminal device.

$${[ \sqrt{{λ}_{1 , 1}} {w}_{1 , 1}^{H} , … , \sqrt{{λ}_{K , {L}_{K}}} {w}_{K , {L}_{K}}^{H} ]}^{T}$$

represents a transpose of

$$[ \sqrt{{λ}_{1 , 1}} {w}_{1 , 1}^{H} , … , \sqrt{{λ}_{K , {L}_{K}}} {w}_{K , {L}_{K}}^{H} ] .$$

“∈ [symbol] ^{r×m}” represents that a matrix dimension of the matrix C is r×m, and r is a total quantity of spatial streams.

Then, a zero-forcing precoding matrix V_{EZF} is calculated for the equivalent channel C, and satisfies:

$${V}_{EZF} = {C}^{+} = {{C}^{H} ( {CC}^{H} )}^{- 1} ∈ {ℂ}^{m \times r}$$

C⁺ represents a pseudo-inverse matrix of C. (CC^{H})⁻¹ represents an inverse matrix of CC^{H}.

Then, the network device may communicate with a part or all of the K first devices based on the precoding matrix V_{EZF}. In the foregoing implementation process, user selection and precoding problems are resolved. However, an operation with high complexity such as SVD and matrix inversion may be performed in a calculation process, resulting in poor performance in power consumption, a delay, and the like for a large-scale MIMO system. Therefore, how to improve processing efficiency and reduce a processing delay in an implementation process of wireless policy optimization is an urgent problem to be resolved.

In a possible embodiment, precoding may be implemented by using a neural network, to improve the processing efficiency and reduce the processing delay. The following briefly describes a neural network that may be used in the embodiments.

### 1. Fully Connected Neural Network

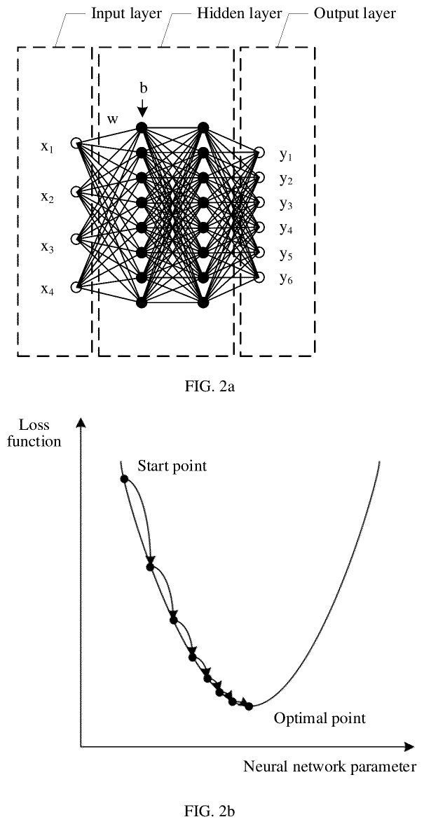

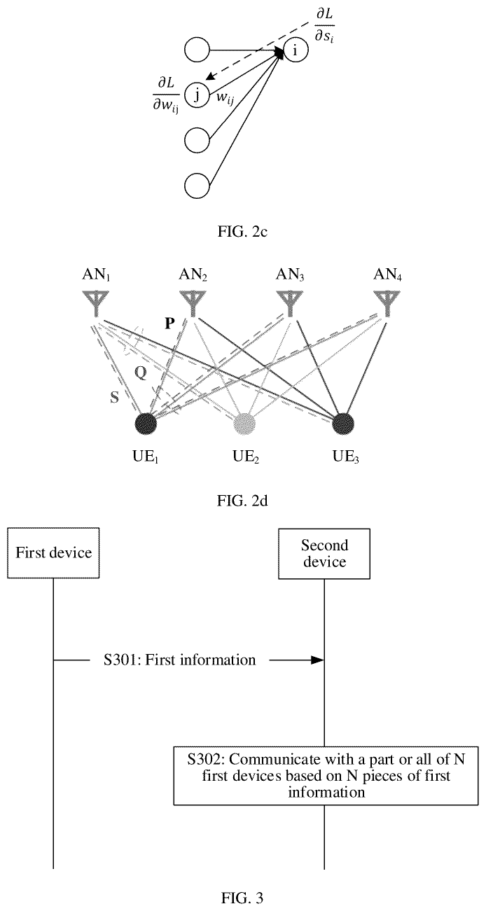

The fully connected neural network is also referred to as a multilayer perceptron (MLP). As shown in FIG. 2a, one MLP includes one input layer (left side), one output layer (right side), and a plurality of hidden layers (middle). Each layer of the MLP includes several nodes, which are referred to as neurons. Neurons at two adjacent layers are connected in pairs.

Optionally, in consideration of neurons at two adjacent layers, an output h of a neuron at a lower layer is a weighted sum of all neurons x at an upper layer connected to the neuron at the lower layer, and may be expressed as follows by using an activation function:

$$h = f ( wx + b )$$

w is a weight matrix, b is a bias vector, and f is the activation function.

Further, optionally, an output of the neural network may be recursively expressed as:

$$y = {f}_{n} ( {w}_{n} {f}_{n - 1} ( … ) + {b}_{n} )$$

n is an index of the neural network layer, 1≤n≤N, and N is a total quantity of layers of the neural network.

In other words, the neural network may be understood as a mapping relationship from an input data set to an output data set. The neural network may be initialized randomly, and a process of obtaining the mapping relationship from random w and b by using existing data is referred to as training of the neural network.

Optionally, a training manner is to evaluate an output result of the neural network by using a loss function. As shown in FIG. 2b, an error may be backpropagated, and a neural network parameter (including w and b) can be iteratively optimized by using a gradient descent method until the loss function reaches a minimum value, for example, an “optimal point” in FIG. 2b. It may be understood that a neural network parameter corresponding to the “optimal point” in FIG. 2b may be used as a neural network parameter in trained AI model information.

Further, optionally, a gradient descent process may be expressed as:

$$θ ← θ - η \frac{\partial L}{\partial θ}$$

θ is a to-be-optimized parameter (including w and b), L is the loss function, η is a learning rate for controlling a gradient descent step or operation, ∂ represents a derivative operation, and

$$\frac{\partial L}{\partial θ}$$

represents taking a derivative or θ with respect to L.

Further, optionally, a chain method for obtaining a bias is used in a backpropagation process. As shown in FIG. 2c, a gradient of a parameter at a previous layer may be obtained through recursive calculation by using a gradient of a parameter at a next layer, and may be expressed as follows:

$$\frac{\partial L}{\partial {w}_{ij}} = \frac{\partial L}{\partial {s}_{i}} \frac{\partial {s}_{i}}{\partial {w}_{ij}}$$

wᵢⱼ is a weight of a connection between a node j and a node i, and sᵢ is an input weighted sum on the node i.

In recent years, it has been proposed in the literatures to use a deep neural network (DNN) to learn resource allocation policies, including power control, link scheduling, precoding, and the like. A deep learning method can jointly optimize a plurality of policies, and the learned policies are robust to channel estimation errors and have low computational complexity. However, training the DNN requires long time, a large quantity of samples, and a large quantity of training parameters. For a conventional fully connected neural network (FNN), training performance may still be poor even if sufficiently high training complexity is provided. Even if the DNN can achieve good performance on a training set, it cannot be ensured that the DNN has a generalization capability for various parameters. Because a wireless environment dynamically changes with time, it is important to improve training efficiency by improving the generalization capability of the DNN or reducing training complexity of the DNN. With the training complexity reduced, the DNN can be retrained by using a newly collected sample when a parameter that cannot be well generalized significantly changes.

Optionally, a manner of improving learning efficiency is to introduce prior knowledge when a DNN structure is designed, which can reduce hypothesis space for the DNN to search for an optimal parameter. For example, by taking advantage of permutation equivariance that exists in many wireless tasks, a permutation-equivariant neural network or a graph neural network (GNN) may be designed to learn a power allocation or precoding policy. Although the training complexity of the DNN may be significantly reduced compared with that of an unstructured FNN, even for a medium-scale problem, the DNN still may require a large quantity of samples to learn a policy, and the policy includes a complex and non-linear operation, such as matrix inversion. Learning performance of the GNN also decreases with an increase of the quantity of samples. This also indicates that the GNN cannot be generalized to different problem scales. To improve the learning efficiency by simplifying a mapping that may be learned by the DNN, a mathematical model may be introduced into a DNN structure. The mathematical model may be an iterative algorithm or a mathematical expression. For example, in a deep unfolding method, the DNN is used to simulate an update process of the iterative algorithm, where only a part of operations or parameters of the algorithm may be learned.

For example, a multi-user precoding scheme is used as an example to describe a solution of wireless policy optimization related to the embodiments. A system model of a single-cell multi-user precoding problem is as follows: A network device may include one base station having m antennas (or m antenna ports), and the base station serves K terminal devices within a coverage area of the base station. A quantity of antennas (or a quantity of antenna ports) of a k^{th} terminal device is n, and a channel between a q^{th} base station antenna and the k^{th} terminal device is denoted as h_{qk}=[h_{q1}, h_{q2}, . . . , h_{qn}]^{T}. In this case, channels from all base station antennas to the k^{th} terminal device are Hₖ=[h₁ₖ, h₂ₖ, . . . , hₘₖ], and channels from a used base station antenna to all the terminal devices are H=[H₁, H₂, . . . , H_{K}]. A problem of finding an optimal precoding matrix V satisfies:

$$P 1 : {max}_{V} {\sum }_{k = 1}^{K} {R}_{k} ( H , V )$$

$$s . t . Tr ( {V}^{H} V ) \leq {P}_{max}$$

$${R}_{k} ( H , V ) = {H}_{k}^{H} {V}_{k} {V}_{k}^{H} {{H}_{k} ( {\sum }_{i = 1 , i \neq k}^{K} {H}_{k}^{H} {V}_{i} {V}_{i}^{H} {H}_{k} + {σ}_{k}^{2} {I}_{{N}_{k}} )}^{- 1}$$

is a throughput of the k^{th} terminal device. Vₖ=[v₁ₖ, v₂ₖ . . . , vₘₖ] is a precoding matrix used when the base station sends data to the k^{th} terminal device, and precoding matrices of a plurality of terminal devices are combined into V=[V₁, V₂, . . . , V_{K}]·Pₘₐₓ is maximum transmit power of the base station. (⋅)^{T} represents a transpose operation. (⋅)^{H} represents a conjugate transpose operation. Tr(⋅) represents a trace operation.

$${σ}_{k}^{2}$$

is noise power. The precoding problem P1 indicates that in a case in which “Tr(V^{H}V)≤Pₘₐₓ” is satisfied, the precoding matrix V is obtained when

$${\sum }_{k = 1}^{K} {R}_{k} ( H , V )$$

reaches a maximum value. In other words, the precoding problem P1 may be understood as obtaining the precoding matrix V, so that a sum of throughputs of a 1^{st} terminal device to a K^{th} terminal device is maximized.

In a possible solution to the precoding problem P1, considering that the precoding problem P1 is a joint precoding and power control problem, the precoding problem P1 is a non-deterministic polynomial hard(NP-hard) problem, an analytical solution cannot be obtained, but an optimal solution V* of the precoding problem P1 satisfies:

$${V}^{⋆} = {( {I}_{N} + \frac{1}{{σ}^{2}} H Λ {H}^{H} )}^{- 1} {HT}^{\frac{1}{2}} = {( {σ}^{2} {I}_{K} + Λ {H}^{H} H )}^{- 1} {\tilde{T}}^{\frac{1}{2}}$$

V* represents the optimal precoding matrix. I_{N} is a unit matrix of m×m. H is the foregoing channel matrix. Λ=diag(λ₁, λ₂, . . . , λ_{K}), and

$${\sum }_{k = 1}^{K} {λ}_{k} = p$$

is satisfied. p is transmit power. σ² is noise power.

$$T = diag ( \frac{{p}_{1}}{{‖ {( {I}_{N} + \frac{1}{{σ}^{2}} H Λ {H}^{H} )}^{- 1} {H}_{1} ‖}^{2}} , … , \frac{{p}_{K}}{{‖ {( {I}_{N} + \frac{1}{{σ}^{2}} H Λ {H}^{H} )}^{- 1} {H}_{K} ‖}^{2}} ) and \tilde{T} = diag ( \frac{{p}_{1}}{{‖ {( {σ}^{2} {I}_{K} + Λ {H}^{H} H )}^{- 1} {H}_{1} ‖}^{2}} , … , \frac{{p}_{K}}{{‖ {( {σ}^{2} {I}_{K} + Λ {H}^{H} H )}^{- 1} {H}_{K} ‖}^{2}} )$$

are power allocation matrices. pₖ is transmit power used when data is sent to the k^{th} terminal device.

When a signal to interference plus noise ratio (SNR) is very low,

$${σ}^{2} \to ∞ , {V}_{{σ}^{2} \to ∞}^{⋆} = {HT}_{{σ}^{2} \to ∞}^{\frac{1}{2}} .$$

This is an MRT precoding policy with power allocation.

When the SNR is very high,

$${σ}^{2} \to 0 , {V}_{{σ}^{2} \to 0}^{⋆} = {H ( Λ {H}^{H} H )}^{- 1} {\tilde{T}}_{{σ}^{2} \to 0}^{\frac{1}{2}} = {H ( {H}^{H} H )}^{- 1} {Λ}^{- 1} {\tilde{T}}_{{σ}^{2} \to 0}^{\frac{1}{2}} .$$

This is a ZF precoding policy with power allocation

When both interference and noise are considered,

$${λ}_{1} = … = {λ}_{K} = \frac{P}{K} , {V}^{*} = {H ( {I}_{K} + \frac{p}{K {σ}^{2}} {H}^{H} H )}^{- 1} {T}^{\frac{1}{2}}$$

may be set. This is an MMSE precoding policy with power allocation.

However, the foregoing solution is applicable to a scenario in which a terminal device side has a single antenna or a terminal device side has a same quantity of antennas and a same quantity of flows. In this case, user selection does not may be performed. For a common MU-MIMO system, when a quantity of spatial streams used by a terminal device may be less than a quantity of antennas of the terminal device, user selection may be performed, to determine a quantity of spatial streams used by each terminal device, and a precoding matrix is obtained based on a user selection result. Consequently, the foregoing solution cannot be used. In addition, the foregoing solution relates to an inversion operation on the matrix (for example,

$${I}_{N} + \frac{1}{{σ}^{2}} H Λ {H}^{H}$$

and σ²I_{K}+ΛH^{H}H, where the matrix dimension is at least m×n, n is the quantity of antenna ports of the terminal device, and m is the quantity of antenna ports of the base station) corresponding to the channel information H, resulting in high complexity.

In another possible solution, an edge-aggregated graph neural network may be used to model and solve the precoding problem. FIG. 2d shows a problem of finding a precoding scheme considering that a quantity of antennas of the base station is 4 (for example, m=4, corresponding to AN₁, AN₂, AN₃, and AN₄ in the figure) and a quantity of terminal devices is 3 (for example, K=3, corresponding to UE₁, UE₂, and UE₃ in the figure). The figure includes two types of nodes: an antenna vertex and a user vertex of the base station. A feature of an edge (or a representation of the edge) may be obtained by using a multilayer edge-aggregated GNN. An output of an edge (q, k) at a 1^{st} layer is denoted as

$${d}_{q k}^{( l )} .$$

The output may be obtained in the following two steps or operations.

Aggregation: for adjacent edges connected to the edge (q, k) through a same vertex, outputs of the adjacent edges at an upper layer are aggregated by an aggregation function. Aggregated outputs of adjacent edges respectively connected to (q, k) by a user k and an antenna q are:

$$\begin{matrix}{u}_{k}^{( l )} = P {L}_{u}^{} {}_{i = 1 , i \neq q}^{N} ( {q}_{u} ( {d}_{i k}^{( l - 1 )} , {P}^{( l )} ) ) \\ {b}_{q}^{( l )} = {PL}_{b} {}_{j = 1 , j \neq k}^{K} ( {q}_{b} ( {d}_{q j}^{( l - 1 )} , {Q}^{( l )} ) )\end{matrix} \qquad ( 1 )$$

PLᵤ(⋅) and PL_{b}(⋅) respectively represent pooling functions that aggregate outputs of the adjacent edges connected to (q, k) by the user k and the antenna n. qᵤ(⋅, P^{(l)}) and q_{b}(⋅, Q^{(l)}) are functions that include trainable parameters P^{(l)} and Q^{(l)} and that are used to extract desired information from adjacent edges connected to the user k and the antenna q.

Combination: to obtain the output of the edge (q, k), a combination function is used to combine an output of the edge (q, k) at an (l−1)^{th} layer with the aggregated outputs:

$${d}_{q k}^{( l )} = C B ( {d}_{q k}^{( l - 1 )} , {u}_{k}^{( l )} , {b}_{q}^{( l )} , {S}^{( l )} ) \qquad ( 2 )$$

CB(⋅) is a combination function including a trainable parameter S^{(l)}.

To ensure that permutation of a same type of vertex (for example, a user or an antenna) does not affect an output of the GNN, qᵤ(⋅, P^{(l)}) and q_{b}(⋅, Q^{(l)}) are the same for different edges, and the pooling functions PLᵤ(⋅) and PL_{b}(⋅) satisfy a commutative law, for example, summation or maximum calculation. For simplicity of symbols, it is assumed that qᵤ(⋅) and q_{b}(⋅) are the same as, and PLᵤ(⋅) and PL_{b}(⋅) are the same. Therefore, subscripts u and b may be omitted. In addition, it is assumed that q(⋅), CB(⋅), PL(⋅), and the trainable parameters remain the same between different layers. Therefore, the superscript (l) of P^{(l)}, Q^{(l)}, S^{(l)} in the foregoing three formulas and in the following may be omitted.

By substituting the formula (1) into the formula (2), an update equation used to update the edge (n, k) at the 1^{st} layer may be obtained as follows:

$${d}_{q k}^{( l )} = C B ( {d}_{q k}^{( l - 1 )} , {PL}_{i = 1 , i \neq q}^{N} ( {q}_{u} ( {d}_{i k}^{( l - 1 )} , {P}^{( l )} ) ) , {PL}_{j = 1 , j \neq k}^{K} ( {q}_{b} ( {d}_{q j}^{( l - 1 )} , {Q}^{( l )} ) ) , {S}^{( l )} ) \qquad ( 3 )$$

The function in the formula (3) is designed, and the parameter is trained by using training data, to obtain the GNN used to obtain the precoding matrix. In other words, an input (for example, an initial value

$${d}_{q k}^{( 0 )}$$

an edge feature) of the GNN is the channel matrix H, and an output (for example, an edge feature

$${d}_{qk }^{( L )}$$

obtained through L rounds of iterations) is a learned precoding matrix \hat{V}. An input-output relationship of the GNN is denoted as \hat{V}=G(H, θ_{G}), where θ_{G} is all trainable parameters in the edge-aggregated GNN.

However, the foregoing solution is also applicable to a scenario in which a terminal device side has a single antenna or a terminal device side has a same quantity of antennas and a same quantity of flows. In this case, user selection does not may be performed. For a common MU-MIMO system, when a quantity of spatial streams used by a terminal device may be less than a quantity of antennas of the terminal device, user selection may be performed, to determine a quantity of spatial streams used by each terminal device, and a precoding matrix is obtained based on a user selection result. Consequently, the foregoing solution cannot be used.

Thus, how to improve processing efficiency and reduce a processing delay based on a neural network in an implementation process of wireless policy optimization is an urgent problem to be resolved.

Therefore, the embodiments provide a communication method and a related device, to improve processing efficiency and reduce a processing delay in a wireless policy optimization process in a manner of determining channel characteristic information by using a neural network, to improve communication efficiency. The following provides detailed descriptions with reference to the accompanying drawings.

FIG. 3 is a diagram of a communication method according to the embodiments. The method includes the following steps or operations.

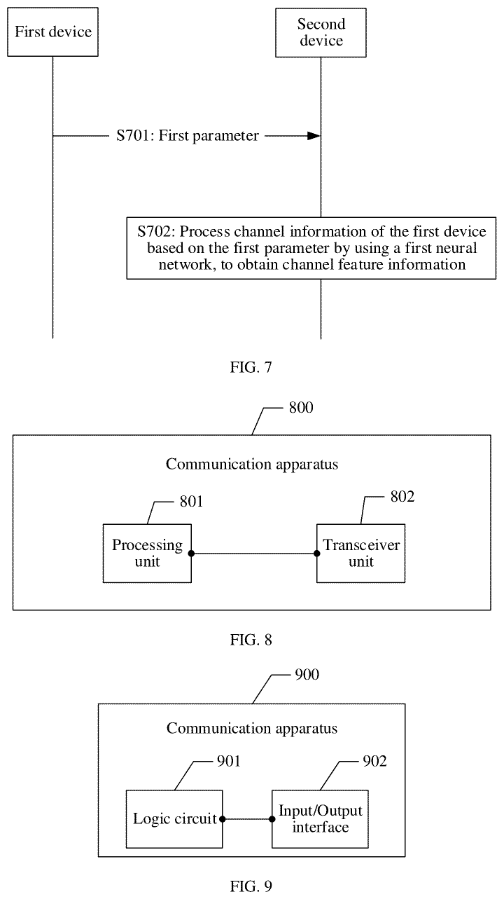

It may be noted that in FIG. 3 (and subsequent accompanying drawings, for example, FIG. 7), the method is illustrated by using an example in which a first device and a second device are used as execution bodies of the interaction illustration. However, an execution body of the interaction illustration is not limited. For example, in FIG. 3 and a corresponding embodiment, S301 is performed by the first device, may be performed by a chip, a chip system, or a processor that supports the first device in implementing the method, or may be a logical module or software that can implement all or a part of functions of the first device. In FIG. 3 and the corresponding embodiment, the second device in S301 and S302 may alternatively be a chip, a chip system, or a processor that supports the second device in implementing the method, or may alternatively be a logical module or software that can implement all or a part of functions of the second device. The first device may be a terminal device or a network device, and the second device may also be a terminal device or a network adevice.

S301: the first device sends first information, where the first information indicates channel characteristic information between the first device and the second device. For the second device, the second device may communicate with K (K is a positive integer) first devices. For example, the second device receives K pieces of first information from the K first devices in step or operation S301, where the K pieces of first information respectively indicate channel characteristic information between the K first devices and the second device.

It should be understood that channel information of the first device may include at least one of channel information of a channel between the first device and the second device and channel information of a channel between the second device and the first device. A receiver of the first information may be the second device. The second device may be a terminal device or a network device. The channel has a plurality of possible forms.

For example, when the first device is a terminal device and the second device is a network device, the channel between the first device and the second device may be an uplink channel, and the channel between the second device and the first device may be a downlink channel.

For another example, when the first device is a network device and the second device is a terminal device, the channel between the first device and the second device may be a downlink channel, and the channel between the second device and the first device may be an uplink channel.

For another example, when the first device is a terminal device and the second device is a terminal device, the channel between the first device and the second device may be a sidelink communication channel.

For another example, when the first device is a network device and the second device is a network device, the channel between the first device and the second device may be a backhaul link communication channel.

Optionally, the channel characteristic information indicated by the first information may include a channel eigenvalue and/or a channel eigenvector. Alternatively, the channel characteristic information indicated by the first information may include other information indicating a channel characteristic. The channel eigenvalue and/or the channel eigenvector may alternatively be other names, for example, a channel characteristic parameter.

In a possible embodiment, a first neural network includes a first module, a second module, and a third module. The first module is used to perform randomized range finder (RRF) processing on the channel information of the first device to obtain an RRF result. The second module is used to perform low rank approximation (LRA) processing on the channel information of the first device and the RRF result to obtain an LRA result. The third module is used to perform singular value decomposition (SVD) processing on the LRA result to obtain the first information.

For example, the first neural network may include the first module used to perform RRF processing, the second module used to perform LRA processing, and the third module used to perform SVD processing. In other words, the first information is obtained by sequentially performing RRF processing, LRA processing, and SVD processing on the channel information of the first device, to provide an implementation of neural network processing.

In a possible embodiment, the first module includes a first submodule, a second submodule, and a third submodule. The first submodule is used to perform data preprocessing on the channel information of the first device based on a preprocessing parameter, to obtain a preprocessing result. The second submodule is used to perform randomized neural network processing on the preprocessing result based on an oversampling parameter, to obtain a randomized neural network processing result. The third submodule is used to perform orthogonal triangular (QR-decomposition, QR) decomposition processing on the randomized neural network processing result to obtain the RRF result.

For example, in a process in which the first module in the first neural network performs RRF processing on the channel information of the first device to obtain the RRF result, a neural network processing process may be affected by using the preprocessing parameter and the oversampling parameter, and the RRF result is determined by sequentially performing processing by using the first submodule, the second submodule, and the third submodule in the first module.

Optionally, in some embodiments, a performance-complexity trade-off can be implemented by adjusting the preprocessing parameter and/or the oversampling parameter (for example, parameter tuning), to adapt to different performance requirements or complexity requirements.

In a possible embodiment, a matrix dimension of a matrix representation of the channel information of the first device is m×n, a matrix dimension of a matrix representation of the LRA result is l×n, m is a quantity of antenna ports of the second device, n is a quantity of antenna ports of the first device, and 1 is the oversampling parameter. A value of l is less than that of m.

For example, the matrix dimension of the matrix representation of the channel information of the first device is m×n, the matrix dimension of the matrix representation of the LRA result used by the third module in the first neural network to perform SVD processing is l×n, and the value of l is less than that of m. Therefore, compared with a process of performing SVD on the channel information in an EZF manner, to obtain the channel characteristic information, in the foregoing process of obtaining the LRA result through LRA processing and performing SVD processing on the LRA result, because complexity of performing SVD on the LRA result is less than that of performing SVD on the channel information, processing efficiency can be further improved, and a processing delay can be further reduced.

In an implementation example, the first device is used as a k^{th} (a value of k ranges from 1 to K) terminal device in the K first devices, and the channel information of the first device may be represented as a channel matrix Hₖ (and/or a conjugate transpose matrix

$${H}_{k}^{H}$$

of the channel matrix), for example, an input of the first neural network may be Hₖ and/or

$${H}_{k}^{H} .$$

In this implementation example, when the channel characteristic information between the first device and the second device includes the channel eigenvalue and/or the channel eigenvector, the channel eigenvalue may be represented as λ_{k,1}, . . . , λ_{k,n} or a matrix Σₖ, and the matrix Σₖ satisfies:

$${Σ}_{k} = [ \begin{matrix}\sqrt{{λ}_{k , 1}} & 0 & … & 0 & … & 0 \\ 0 & \sqrt{{λ}_{k , 2}} & … & 0 & … & 0 \\ ⋮ & ⋮ & ⋱ & 0 & … & 0 \\ 0 & 0 & … & \sqrt{{λ}_{k , n}} & … & 0\end{matrix} ]$$

λ_{k,1}, . . . , λ_{k,n} represent channel eigenvalues, and n represents a quantity of antennas (or a quantity of antenna ports) of the k^{th} terminal device.

The channel eigenvector may be represented as w_{k,1}, w_{k,2}, . . . , w_{k,m} or a matrix Wₖ, and the matrix Wₖ satisfies:

$${W}_{k} = [ {w}_{k , 1} , {w}_{k , 2} , … , {w}_{k , m} , ]$$

w_{k,1}, w_{k,2}, . . . , w_{k,m} represent channel eigenvectors, and m represents a quantity of antennas (or a quantity of antenna ports) of the second device.

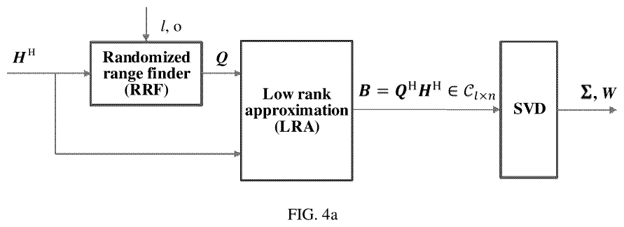

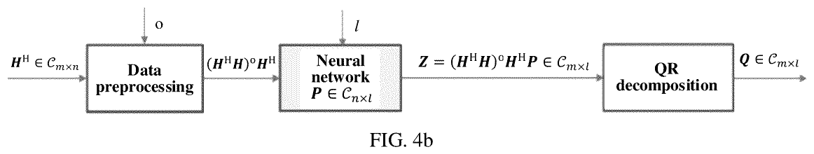

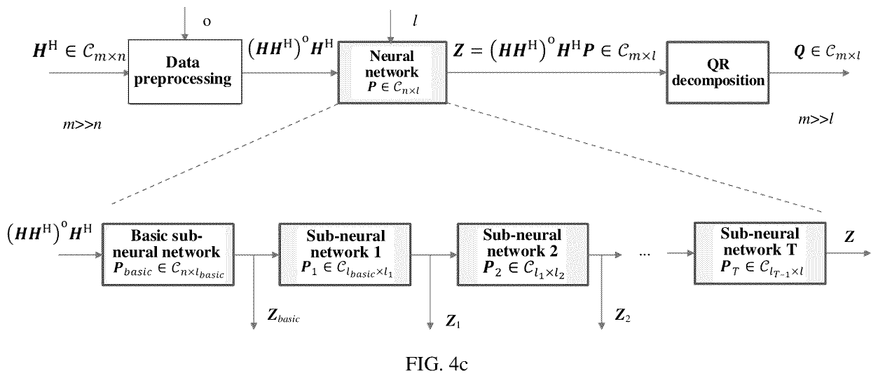

FIG. 4a is used as an example. In the three modules included in the first neural network, the first module may be a RRF module in the figure, the second module may be a LRA module in the figure, and the third module may be an SVD module in the figure. The following describes an example of a process performed by the three modules.

For the RRF module in FIG. 4a, a conjugate transpose H^{H} ∈ [symbol] _{m×n} (for brevity of description, a subscript k is omitted in this example) of a channel matrix of the k^{th} terminal device, a data preprocessing parameter o, and an oversampling parameter l are input, and a matrix Q∈ [symbol] _{m×l} is output, so that H^{H}≈QQ^{H}H^{H}. A structure of the RRF module is shown in FIG. 4a, including a trainable neural network part, and a to-be-trained parameter is P.

For example, the first submodule, the second submodule, and the third submodule included in the RRF module may be represented as a data preprocessing module, a neural network module, and a QR decomposition module in FIG. 4b. In the RRF module shown in FIG. 4b, the data preprocessing module preprocesses the input H^{H} to obtain (H^{H}H)^{o}H^{H}. The preprocessing operation may accelerate a decrease of an eigenvalue with a small value, so that a result is more accurate. A larger value of the preprocessing parameter o indicates a faster decrease of a small eigenvalue, and a more accurate result, but higher complexity. A larger oversampling parameter indicates a smaller difference between a channel SVD result obtained by using this solution and a real channel SVD result, for example, better performance. Then, a preprocessing result is input into the neural network module, and the neural network module obtains Z=(H^{H}H)^{o}H^{H}P∈ [symbol] _{m×l}. Selection of the oversampling parameter l affects performance and complexity of the RRF module. A larger value of the oversampling parameter l indicates higher complexity but better performance (which may be understood as that a smaller difference between the channel SVD result obtained by using this solution and the real channel SVD result indicates better performance). Then, the QR decomposition module performs QR decomposition on the matrix Z, for example, Z=QR, to obtain the matrix Q E [symbol] _{m×l}.

The LRA module in FIG. 4a processes H^{H} by using the matrix Q output by the RRF module, to obtain B=Q^{H}H^{H} ∈ [symbol] _{l×n}.

The SVD module in FIG. 4a performs SVD on B output by the LRA module, for example, B=ǓΣ̌W̌^{H}. Because H^{H}≈QQ^{H}H^{H}, and B=Q^{H}H^{H} H^{H}≈QB=QǓΣ̌W̌^{H}, for example, a channel eigenvalue matrix Σ≈Σ̌, and a channel eigenvector matrix W≈W̌. Through SVD on the matrix B, an approximate value of SVD of the matrix H^{H} is obtained. A dimension of H^{H} is m×n, where m is a quantity of base station antennas, and n is a quantity of user antennas. In some systems, generally, m is greater than n, or m is far greater than n (which may be denoted as m>>n). A dimension of the matrix B is l×n, where l is generally less than m, or l is far less than m (which may be denoted as l<<m). Therefore, complexity of performing SVD on the matrix B is far less than complexity of directly performing SVD on H^{H}.

In a possible embodiment, in the second submodule included in the RRF module in the first neural network, the second submodule may include a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing. For example, when the second submodule in the first neural network performs randomized neural network processing on the preprocessing result based on the oversampling parameter, to obtain the randomized neural network processing result, performance and complexity of the second submodule may be adjusted by adjusting a value of T, to improve flexibility of implementing the solution, to adapt to different performance requirements or complexity requirements.

FIG. 4c is used as an example. The first sub-neural network included in the second submodule (for example, the neural network module in FIG. 4b) may be a basic sub-neural network in FIG. 4c, and the T second sub-neural networks may be a sub-neural network 1, a sub-neural network 2, . . . , and a sub-neural network T (in this example, T is greater than 2) in FIG. 4c. A neural network in the RRF module may be implemented by a plurality of cascaded neural networks, including one basic sub-neural network whose parameter is P_{basic} and T sub-neural networks whose parameters are Pₜ, t=[1, 2, . . . , T]. The basic sub-neural network provides minimum performance guarantee and minimum complexity. Based on the basic sub-neural network, one or more other sub-neural networks may be selected based on performance and complexity requirements, to improve performance.

In a possible embodiment, that the first information is obtained by the first neural network by processing the channel information of the first device includes: the first information is obtained by the first neural network by processing the channel information of the first device based on a first parameter, where the first parameter includes the oversampling parameter and/or the preprocessing parameter. For example, the first information indicating the channel characteristic information between the first device and the second device may be obtained by processing the channel information of the first device based on the first parameter. Therefore, the performance-complexity trade-off can be implemented by adjusting the first parameter (for example, parameter tuning), to adapt to different performance requirements or complexity requirements.

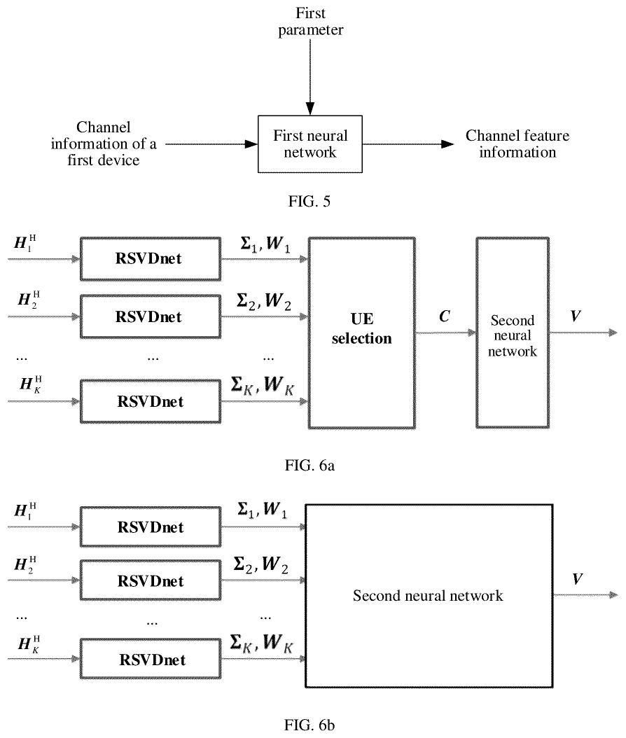

For example, as shown in FIG. 5, the first neural network may not be limited to the embodiments shown in FIG. 4a to FIG. 4c. The first device may process the channel information of the first device based on the first parameter by using the first neural network, to obtain the channel characteristic information.

In a possible embodiment, in the method shown in FIG. 3, the method further includes: the first device receives indication information indicating the oversampling parameter and/or the preprocessing parameter. For example, after receiving the indication information indicating the oversampling parameter and/or the preprocessing parameter, the first device may determine the first information based on the indication information. In other words, the foregoing solution may be applicable to an implementation scenario in which another device (for example, the second device) determines/indicates the oversampling parameter and/or the preprocessing parameter. Therefore, implementation complexity of the first device can be reduced, and the second device can flexibly configure performance and/or complexity of a plurality of pieces of first information obtained by a plurality of first devices that may exist.

In a possible embodiment, in the method shown in FIG. 3, the method further includes: the first device sends indication information indicating the oversampling parameter and/or the preprocessing parameter. For example, when the oversampling parameter and/or the preprocessing parameter are/is preconfigured on the first device, the first device may further send, to another device (for example, the second device), the indication information indicating the oversampling parameter and/or the preprocessing parameter, so that another device can determine a performance and/or complexity configuration of the first device based on the indication information.

In addition, in the foregoing solution, the first device can determine the oversampling parameter and/or the preprocessing parameter without an indication from another device, so that signaling overheads can be reduced, and the first device can implement the performance and/or complexity configuration based on local computing power (or redundant computing power).

S302: the second device communicates with a part or all of the K first devices based on the K pieces of first information.

It should be understood that: that the second device communicates with the part or all of the K first devices based on the K pieces of first information may be understood as follows: the second device receives signals of the part or all of the K first devices based on the K pieces of first information, and/or the second device sends signals to the part or all of the K first devices based on the K pieces of first information.

It should be understood that because a network resource is limited, in an implementation process in which the second device communicates with the part or all of the K first devices based on the K pieces of first information, when a current network resource is less than a resource used to carry the signals of the K first devices, the second device may send signals to or receive signals from the part of the K first devices; or when a current network resource is greater than or equal to a resource used to carry the signals of the K first devices, the second device may send signals to or receive signals from the K first devices.

It should be noted that for the second device, before step or operation S302, the second device may determine (or obtain) the K pieces of first information in a plurality of manners, which are described below.

Implementation 1: the second device receives the K pieces of first information by using the process of step or operation S301, to determine (or obtain) the K pieces of first information.

In Implementation 1, the second device may determine the K pieces of first information in a manner of receiving the K pieces of first information, so that the foregoing solution may be applied to a scenario in which a neural network is configured on the first device. In other words, for the second device, the second device may not locally obtain the K pieces of first information through neural network processing. Therefore, implementation complexity of the second device can be reduced.

Implementation 2: that the second device determines the K pieces of first information includes: the second device determines the K pieces of first information based on the channel information between the K first devices and the second device.

In Implementation 2, the second device may locally determine the K pieces of first information by using the channel information between the K first devices and the second device, and the second device may not perform the process of step or operation S301 (for example, step or operation S301 is an optional step or operation), so that the foregoing solution may be applied to a scenario in which a neural network is configured on the second device. In other words, for the second device, the second device may locally obtain the K pieces of first information through neural network processing, so that the signaling overheads can be reduced, and the implementation complexity of the first device can be reduced.

In a possible embodiment, communication parameters of the K first devices include precoding information of the K first devices. The communication parameters of the K first devices determined by the second device based on the K pieces of first information may include the precoding information of the K first devices, so that the foregoing solution can be used to resolve a precoding solution problem in wireless policy optimization.

Optionally, when a value of K is greater than 1, the foregoing solution can resolve the precoding solution problem in wireless policy optimization in a multi-user multiple-input multiple-output MU-MIMO scenario.

Optionally, the communication parameters of the K first devices may include one or more of device selection and scheduling information, and MIMO detection and demodulation information.

In a possible embodiment, the K pieces of first information are used to determine the communication parameters of the K first devices. Correspondingly, in step or operation S302, that the second device communicates with the part or all of the K first devices based on the K pieces of first information includes: the second device communicates with the part or all of the K first devices based on the communication parameters of the K first devices.

In an implementation example, that the K pieces of first information are used to determine the communication parameters of the K first devices includes: equivalent channel information determined based on the K pieces of first information is used as an input of a second neural network, and is processed by the second neural network to obtain the communication parameters of the K first devices. The equivalent channel information indicates an equivalent channel obtained based on the channel information of the K first devices and a quantity of spatial streams of the K first devices.

In another implementation example, that the K pieces of first information are used to determine the communication parameters of the K first devices includes: the K pieces of first information are used as an input of a second neural network, and are processed by the second neural network to obtain the communication parameters of the K first devices.

Therefore, determining the communication parameter by using a neural network can improve the processing efficiency and reduce the processing delay.

For example, an example in which the first device is a terminal device and the second device is a network device is used. The communication parameters of the K first devices may include the precoding information (denoted as V) of the K first devices. The foregoing implementation process may be understood as a problem that the network device (for example, the second device) determines precoding of the K terminal devices (for example, the K first devices). As shown in FIG. 6a and FIG. 6b, the first neural network may be a randomized singular value decomposition network (RSVDnet) in the figures. For implementation processes of an RRF module, an LRA module, and an SVD module included in the RSVDnet, refer to the foregoing descriptions.

It may be understood that as described above, a process in which the RSVDnet processes the channel information to obtain the channel characteristic information may be performed by the terminal device, or may be performed by the network device.

In FIG. 6a, after obtaining channel characteristic information (including a channel eigenvalue Σ₁ and/or a channel eigenvalue W₁ of a 1^{st} terminal device, a channel eigenvalue Σ₂ and/or a channel eigenvalue W₂ of a 2^{nd} terminal device, . . . , and a channel eigenvalue Σ_{K} and/or a channel eigenvalue W_{K} of a K^{th} terminal device, where K is, for example, greater than 2) of K terminal devices, the RSVDnet may perform processing by using a user selection (UE selection) module to obtain equivalent channel information. Then, the equivalent channel information is used as the input of the second neural network, and is processed by the second neural network to obtain the precoding information V.

In FIG. 6b, after the RSVDnet obtains the channel characteristic information of the K terminal devices, the channel characteristic information may be used as the input of the second neural network and processed by the second neural network to obtain the precoding information V.

Optionally, the second neural network may be a GNN, a convolutional neural network, a fully connected neural network, a transformer, or another type of neural network.

Based on FIG. 3 and a related solution, the first information sent by the first device in step or operation S301 indicates the channel characteristic information between the first device and the second device, and the first information is obtained by the first neural network by processing the channel information of the first device. In other words, the first device may obtain, through neural network processing, the channel characteristic information for wireless policy optimization. Subsequently, after the first device sends the first information indicating the channel characteristic information, the second device can implement wireless policy optimization in step or operation S301 based on the first information. Therefore, determining the channel characteristic information by using a neural network can improve processing efficiency and reduce a processing delay in a wireless policy optimization process, to improve communication efficiency.

In an application example, in an application scenario in which the first device is a terminal device having 32 antennas, and the second device is a base station having 1024 antennas, SVD may be performed on channel information (CDL-C) of a MIMO channel in the following plurality of manners, to obtain channel characteristic information. A result error and running time statistics are shown in Table 1.

TABLE 1

| | Error (singular | Average running time | |
|---|---|---|---|
| Algorithm | value L2 norm) | (199batch) | |
| Lanczo SVD | 0.11927 | 697.511 | μs |
| RSVD | 1.60217 | 568.929 | μs |
| First neural network (for | 0.06386 | 507.671 | μs |
| example, the RSVDnet in | | | |
| FIG. 6a or FIG. 6b) | | | |
| JacobiSVD | / | 47365.239 | μs |

JacobiSVD is a common baseline SVD algorithm, and Lanczo SVD and RSVD are two simplified SVD methods free of a neural network. It can be understood that implementation by the first neural network in the solution provided in the embodiments has a minimum error compared with the baseline algorithm, and is also better than the baseline algorithm and the other two simplified algorithms in average running time.

In addition, impact of the oversampling parameter and the preprocessing parameter on complexity and performance is shown in Table 2 through experiments.

TABLE 2

| | | Error (singular | | |
|---|---|---|---|---|
| Algorithm | | value L2 norm) | Average running time | |
| JacobiSVD | | / | 47365.239 | μs |
| l = 5, and o = 2 | RSVD-Net | 0.85086 | 424.420 | μs |
| l = 6, and o = 1 | RSVD-Net | 0.39487 | 410.797 | μs |
| l = 6, and o = 2 | RSVD-Net | 0.06386 | 507.671 | μs |
| l = 7, and o = 1 | RSVD-Net | 0.17603 | 493.733 | μs |

It can be understood that as the oversampling parameter and/or the preprocessing parameter increase/increases, the average running time also increases, but the error decreases, for example, the performance is improved.

FIG. 7 is another diagram of a communication method according to the embodiments. The method includes the following steps or operations.

S701: a first device sends a first parameter. Correspondingly, a second device receives the first parameter.

S702: the second device processes channel information of the first device based on the first parameter by using a first neural network, to obtain channel characteristic information.

It may be noted that for implementation of the first device, the second device, the first neural network, the channel information of the first device, the channel characteristic information, the first parameter, and the like, refer to the descriptions in FIG. 3 and the related embodiments.

According to the solution shown in FIG. 7, indication information received by the second device in step or operation S701 indicates the first parameter, and the first parameter is used by the first neural network to process the channel information of the first device to obtain the channel characteristic information. In other words, after the second device receives the indication information, the second device may obtain, in step or operation S702 based on the first parameter through neural network processing, the channel characteristic information for wireless policy optimization. Therefore, determining the channel characteristic information by using a neural network can improve processing efficiency and reduce a processing delay in a wireless policy optimization process, to improve communication efficiency.

Refer to FIG. 8. An embodiment provides a communication apparatus 800. The communication apparatus 800 can implement a function of the first device (the first device is a terminal device or a network device) in the foregoing method embodiments, and therefore, can also implement the beneficial effects of the foregoing method embodiments. In this embodiment, the communication apparatus 800 may be the first device, or may be an integrated circuit, an element, or the like, for example, a chip, inside the first device. In the following embodiments, an example in which the communication apparatus 800 is the first device is used for description.

In a possible embodiment, when the apparatus 800 is configured to perform the method performed by the first device in any one of the foregoing embodiments, the apparatus 800 includes a processing unit 801 and a transceiver unit 802. The processing unit 801 is configured to determine first information, where the first information indicates channel characteristic information between the first device and a second device, the channel characteristic information includes a channel eigenvalue and/or a channel eigenvector, and the first information is obtained by a first neural network by processing channel information of the first device. The transceiver unit 802 is configured to send the first information.

In a possible embodiment, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the first information.

In a possible embodiment, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

In a possible embodiment, the first module includes a first submodule, a second submodule, and a third submodule. The first submodule is used to perform data preprocessing on the channel information of the first device based on a preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

In a possible embodiment, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

In a possible embodiment, that the first information is obtained by the first neural network by processing the channel information of the first device includes: the first information is obtained by the first neural network by processing the channel information of the first device based on a first parameter, where the first parameter includes the oversampling parameter and/or the preprocessing parameter.

In a possible embodiment, the transceiver unit 802 is further configured to receive indication information indicating the oversampling parameter and/or the preprocessing parameter.

In a possible embodiment, the transceiver unit 802 is further configured to send indication information indicating the oversampling parameter and/or the preprocessing parameter.

In a possible embodiment, when the apparatus 800 is configured to perform the method performed by the second device in any one of the foregoing embodiments, the apparatus 800 includes a processing unit 801 and a transceiver unit 802. The processing unit 801 is configured to determine N pieces of first information, where the N pieces of first information respectively indicate channel characteristic information between N first devices and the second device, the channel characteristic information includes a channel eigenvalue and/or a channel eigenvector, the first information is obtained by a first neural network by processing channel information of the first device, and N is an integer greater than or equal to 1. The transceiver unit 802 is configured to communicate with a part or all of the N first devices based on the N pieces of first information.

In a possible embodiment, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the first information.

In a possible embodiment, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

In a possible embodiment, the first module includes a first submodule, a second submodule, and a third submodule. The first submodule is used to perform data preprocessing on the channel information of the first device based on a preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

In a possible embodiment, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

In a possible embodiment, that the first information is obtained by the first neural network by processing the channel information of the first device includes: the first information is obtained by the first neural network by processing the channel information of the first device based on a first parameter, where the first parameter includes the oversampling parameter and/or the preprocessing parameter.

In a possible embodiment, the transceiver unit 802 is further configured to receive indication information indicating the oversampling parameter and/or the preprocessing parameter.

In a possible embodiment, the transceiver unit 802 is further configured to send indication information indicating the oversampling parameter and/or the preprocessing parameter.

In a possible embodiment, the processing unit 801 is configured to receive the K pieces of first information via the transceiver unit 802.

In a possible embodiment, the processing unit 801 is configured to determine the K pieces of first information based on the channel information between the K first devices and the second device.

In a possible embodiment, the K pieces of first information are used to determine communication parameters of the K first devices. The transceiver unit 802 is configured to communicate with the part or all of the K first devices based on the communication parameters of the K first devices.

In a possible embodiment, that the K pieces of first information are used to determine the communication parameters of the K first devices includes: equivalent channel information determined based on the K pieces of first information is used as an input of a second neural network, and is processed by the second neural network to obtain the communication parameters of the K first devices. The equivalent channel information indicates an equivalent channel obtained based on the channel information of the K first devices and a quantity of spatial streams of the K first devices.

In a possible embodiment, that the K pieces of first information are used to determine the communication parameters of the K first devices includes: the K pieces of first information are used as an input of a second neural network, and are processed by the second neural network to obtain the communication parameters of the K first devices.

In a possible embodiment, the communication parameters of the K first devices include precoding information of the K first devices.

In a possible embodiment, when the apparatus 800 is configured to perform the method performed by the first device in any one of the foregoing embodiments, the apparatus 800 includes a processing unit 801 and a transceiver unit 802. The processing unit 801 is configured to determine a first parameter, where the first parameter is used by a first neural network to process channel information of the first device to obtain channel characteristic information, and the channel characteristic information includes a channel eigenvalue and/or a channel eigenvector. The transceiver unit 802 is configured to send indication information indicating the first parameter.

In a possible embodiment, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the channel characteristic information.

In a possible embodiment, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

In a possible embodiment, the first parameter includes the oversampling parameter and/or a preprocessing parameter, and the first module includes a first submodule, a second submodule, and a third submodule. The first submodule is used to perform data preprocessing on the channel information of the first device based on the preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

In a possible embodiment, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

In a possible embodiment, the channel characteristic information of the first device is used to determine a communication parameter of the first device.

In a possible embodiment, that the channel characteristic information is used to determine the communication parameter of the first device includes: equivalent channel information determined based on the channel characteristic information is used as an input of a second neural network, and is processed by the second neural network to obtain the communication parameter of the first device. The equivalent channel information indicates an equivalent channel obtained based on the channel information of the first device and a quantity of spatial streams of the first device.

In a possible embodiment, that the channel characteristic information is used to determine the communication parameter of the first device includes: the channel characteristic information is used as an input of a second neural network, and is processed by the second neural network to obtain the communication parameter of the first device.

In a possible embodiment, the communication parameter of the first device includes precoding information of the first device.

In a possible embodiment, when the apparatus 800 is configured to perform the method performed by the second device in any one of the foregoing embodiments, the apparatus 800 includes a processing unit 801 and a transceiver unit 802. The transceiver unit 802 is configured to receive indication information indicating a first parameter. The processing unit 801 is configured to process channel information of a first device based on the first parameter by using a first neural network, to obtain channel characteristic information, where the channel characteristic information includes a channel eigenvalue and/or a channel eigenvector.

In a possible embodiment, the first neural network includes a first module, a second module, and a third module. The first module is used to perform RRF processing on the channel information of the first device to obtain an RRF result. The second module is used to perform LRA processing on the channel information of the first device and the RRF result to obtain an LRA result. The third module is used to perform SVD processing on the LRA result to obtain the channel characteristic information.

In a possible embodiment, a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter. A value of l is less than that of m.

In a possible embodiment, the first parameter includes the oversampling parameter and/or a preprocessing parameter, and the first module includes a first submodule, a second submodule, and a third submodule. The first submodule is used to perform data preprocessing on the channel information of the first device based on the preprocessing parameter, to obtain a preprocessing result. The second submodule is used to perform randomized neural network processing on the preprocessing result based on the oversampling parameter, to obtain a randomized neural network processing result. The third submodule is used to perform QR decomposition processing on the randomized neural network processing result to obtain the RRF result.

In a possible embodiment, the second submodule includes a first sub-neural network and T second sub-neural networks, where T is an integer greater than or equal to 0. The first sub-neural network is used to perform a basic randomization operation of the randomized neural network processing. The second sub-neural network is used to perform an enhanced randomization operation of the neural network processing.

In a possible embodiment, the channel characteristic information of the first device is used to determine a communication parameter of the first device.

In a possible embodiment, that the channel characteristic information is used to determine the communication parameter of the first device includes: equivalent channel information determined based on the channel characteristic information is used as an input of a second neural network, and is processed by the second neural network to obtain the communication parameter of the first device. The equivalent channel information indicates an equivalent channel obtained based on the channel information of the first device and a quantity of spatial streams of the first device.

In a possible embodiment, that the channel characteristic information is used to determine the communication parameter of the first device includes: the channel characteristic information is used as an input of a second neural network, and is processed by the second neural network to obtain the communication parameter of the first device.

In a possible embodiment, the communication parameter of the first device includes precoding information of the first device.

It may be noted that for details of content such as an information execution process of the unit of the communication apparatus 800, refer to the descriptions in the foregoing method embodiments. Details are not described herein again.

FIG. 9 is another diagram of a structure of a communication apparatus 900 according to the embodiments. The communication apparatus 900 includes at least an input/output interface 902. The communication apparatus 900 may be a chip or an integrated circuit.

Optionally, the communication apparatus further includes a logic circuit 901.

The transceiver unit 802 shown in FIG. 8 may be a communication interface. The communication interface may be the input/output interface 902 in FIG. 9, and the input/output interface 902 may include an input interface and an output interface. Alternatively, the communication interface may be a transceiver circuit, and the transceiver circuit may include an input interface circuit and an output interface circuit.

Optionally, the logic circuit 901 is configured to determine first information, where the first information indicates channel characteristic information between a first device and a second device, the channel characteristic information includes a channel eigenvalue and/or a channel eigenvector, and the first information is obtained by a first neural network by processing channel information of the first device. The input/output interface 902 is configured to send the first information.

Optionally, the logic circuit 901 is configured to determine K pieces of first information, where the K pieces of first information respectively indicate channel characteristic information between K first devices and a second device, the channel characteristic information includes a channel eigenvalue and/or a channel eigenvector, the first information is obtained by a first neural network by processing channel information of the first device, and N is an integer greater than or equal to 1. The input/output interface 902 is configured to communicate with a part or all of the K first devices based on the K pieces of first information.

Optionally, the logic circuit 901 is configured to determine a first parameter, where the first parameter is used by a first neural network to process channel information of a first device to obtain channel characteristic information, and the channel characteristic information includes a channel eigenvalue and/or a channel eigenvector. The input/output interface 902 is configured to send indication information indicating the first parameter.

Optionally, the input/output interface 902 is configured to receive indication information indicating a first parameter. The logic circuit 901 is configured to process channel information of a first device based on the first parameter by using a first neural network, to obtain channel characteristic information, where the channel characteristic information includes a channel eigenvalue and/or a channel eigenvector.

The logic circuit 901 and the input/output interface 902 may further perform other steps or operations performed by the first device or the second device in any embodiment, and achieve corresponding beneficial effects. Details are not described herein again.

In a possible embodiment, the processing unit 801 shown in FIG. 8 may be the logic circuit 901 in FIG. 9.

Optionally, the logic circuit 901 may be a processing apparatus. A part or all of functions of the processing apparatus may be implemented by using software. The part or all of the functions of the processing apparatus may be implemented by using the software.

Optionally, the processing apparatus may include a memory and a processor. The memory is configured to store a computer program. The processor reads and executes the computer program stored in the memory, to perform corresponding processing and/or steps or operations in any method embodiment.

Optionally, the processing apparatus may include only a processor. A memory configured to store a computer program is located outside the processing apparatus. The processor is connected to the memory through a circuit/wire, to read and execute the computer program stored in the memory. The memory and the processor may be integrated together, or may be physically independent of each other.

Optionally, the processing apparatus may be one or more chips or one or more integrated circuits. For example, the processing apparatus may be one or more field programmable gate arrays (FPGAs), application-specific integrated circuits (ASICs), systems on chip (SoCs), central processing units (CPUs), network processors (NPs), digital signal processors (DSPs), microcontroller units (MCUs), programmable logic devices (PLDs), or other integrated chips, or any combination of the foregoing chips or processors.

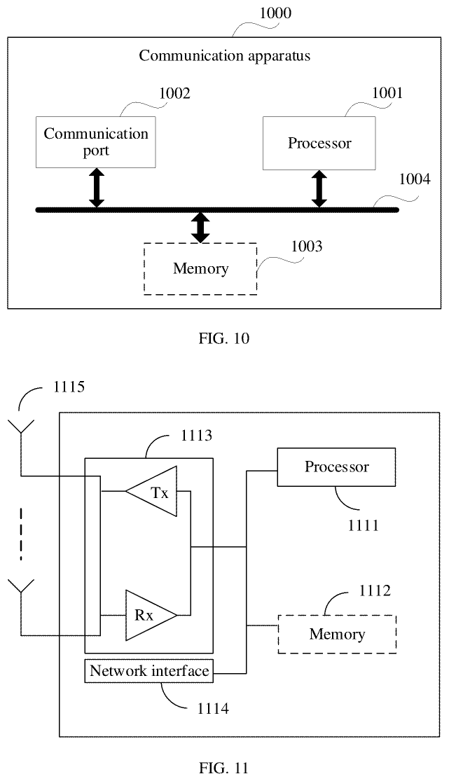

FIG. 10 shows a communication apparatus 1000 in the foregoing embodiment according to an embodiment. The communication apparatus 1000 may be the communication apparatus used as a terminal device in the foregoing embodiment. In the example shown in FIG. 10, the terminal device is implemented by using a terminal device (or a component in a terminal device).

In a possible diagram of a logical structure of the communication apparatus 1000, the communication apparatus 1000 may include but is not limited to at least one processor 1001 and a communication port 1002.

Further, optionally, the apparatus may further include at least one of a memory 1003 and a bus 1004. In this embodiment, the at least one processor 1001 is configured to control an action of the communication apparatus 1000.

In addition, the processor 1001 may be a central processing unit, a general-purpose processor, a digital signal processor, an application-specific integrated circuit, a field programmable gate array or another programmable logic device, a transistor logic device, a hardware component, or any combination thereof. The processor may implement or execute various example logical blocks, modules, and circuits described with reference to content in the embodiments. Alternatively, the processor may be a combination implementing a computing function, for example, a combination of one or more microprocessors, or a combination of a digital signal processor and a microprocessor. It may be clearly understood by a person skilled in the art that, for the purpose of convenient and brief description, for a detailed working process of the foregoing system, apparatus, and unit, refer to a corresponding process in the foregoing method embodiments, and details are not described herein again.

It should be noted that the communication apparatus 1000 shown in FIG. 10 may be configured to implement steps or operations implemented by the terminal device in the foregoing method embodiments, and achieve effects corresponding to the terminal device. For an embodiment of the communication apparatus shown in FIG. 10, refer to the descriptions in the foregoing method embodiments. Details are not described herein again.

FIG. 11 is a diagram of a structure of a communication apparatus 1100 in the foregoing embodiment according to an embodiment. The communication apparatus 1100 may be the communication apparatus used as the network device in the foregoing embodiment. In the example shown in FIG. 11, the communication apparatus is implemented by using a network device (or a component in a network device). For a structure of the communication apparatus, refer to the structure shown in FIG. 11.

The communication apparatus 1100 includes at least one processor 1111 and at least one network interface 1114. Further, optionally, the communication apparatus further includes at least one memory 1112, at least one transceiver 1113, and one or more antennas 1115. The processor 1111, the memory 1112, the transceiver 1113, and the network interface 1114 are connected, for example, connected through a bus. In this embodiment, the connection may include various types of interfaces, transmission lines, buses, or the like. This is not limited in this embodiment. The antenna 1115 is connected to the transceiver 1113. The network interface 1114 is configured to enable the communication apparatus to communicate with another communication device through a communication link. For example, the network interface 1114 may include a network interface between the communication apparatus and a core network device, for example, an S1 interface. The network interface may include a network interface between the communication apparatus and another communication apparatus (for example, another network device or core network device), for example, an X2 or Xn interface.

The processor 1111 is configured to: process a communication protocol and communication data, control the entire communication apparatus, execute a software program, and process data of the software program, for example, is configured to support the communication apparatus in performing actions described in embodiments. The communication apparatus may include a baseband processor and a central processing unit. The baseband processor is configured to process the communication protocol and the communication data. The central processing unit is configured to control the entire network device, execute the software program, and process the data of the software program. The processor 1111 in FIG. 11 may integrate functions of the baseband processor and the central processing unit. A person skilled in the art may understand that the baseband processor and the central processing unit may be processors independent of each other, and are interconnected by using a technology, for example, a bus. A person skilled in the art may understand that the terminal device may include a plurality of baseband processors to adapt to different network standards, the terminal device may include a plurality of central processing units to enhance processing capabilities of the terminal device, and components of the terminal device may be connected by using various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the memory in a form of the software program, and the processor executes the software program to implement a baseband processing function.

The memory is configured to store the software program and data. The memory 1112 may exist independently, and is connected to the processor 1111. Optionally, the memory 1112 may be integrated with the processor 1111, for example, integrated into a chip. The memory 1112 can store program code for executing the solutions in embodiments, and the processor 1111 controls the execution. Various types of executed computer program code may also be considered as a driver of the processor 1111.

FIG. 11 shows only one memory and one processor. In some terminal devices, there may be a plurality of processors and a plurality of memories. The memory may also be referred to as a storage medium, a storage device, or the like. The memory may be a storage element on a same chip as the processor, for example, an on-chip storage element, or may be an independent storage element. This is not limited in this embodiment.

The transceiver 1113 may be configured to support receiving or sending of a radio frequency signal between the communication apparatus and a terminal. The transceiver 1113 may be connected to the antenna 1115. The transceiver 1113 includes a transmitter Tx and a receiver Rx. For example, the one or more antennas 1115 may receive a radio frequency signal. The receiver Rx of the transceiver 1113 is configured to: receive the radio frequency signal from the antenna, convert the radio frequency signal into a digital baseband signal or a digital intermediate frequency signal, and provide the digital baseband signal or the digital intermediate frequency signal to the processor 1111, so that the processor 1111 performs further processing, for example, demodulation and decoding, on the digital baseband signal or the digital intermediate frequency signal. In addition, the transmitter Tx of the transceiver 1113 is further configured to: receive a modulated digital baseband signal or digital intermediate frequency signal from the processor 1111, convert the modulated digital baseband signal or digital intermediate frequency signal into a radio frequency signal, and send the radio frequency signal through the one or more antennas 1115. For example, the receiver Rx may selectively perform one-level or multi-level down mixing processing and analog-to-digital conversion processing on the radio frequency signal, to obtain the digital baseband signal or the digital intermediate frequency signal. A sequence of the down mixing processing and the analog-to-digital conversion processing may be adjusted. The transmitter Tx may selectively perform one-level or multi-level up mixing processing and digital-to-analog conversion processing on the modulated digital baseband signal or digital intermediate frequency signal, to obtain the radio frequency signal. A sequence of the up mixing processing and the digital-to-analog conversion processing may be adjusted. The digital baseband signal and the digital intermediate frequency signal may be collectively referred to as a digital signal.

The transceiver 1113 may also be referred to as a transceiver unit, a transceiver machine, a transceiver apparatus, or the like. Optionally, a component that is in the transceiver unit and that is configured to implement a receiving function may be considered as a receiving unit, and a component that is in the transceiver unit and that is configured to implement a sending function may be considered as a sending unit. In other words, the transceiver unit includes the receiving unit and the sending unit. The receiving unit may also be referred to as a receiver machine, an input port, a receiver circuit, or the like. The sending unit may be referred to as a transmitter machine, a transmitter, a transmitter circuit, or the like.

It should be noted that the communication apparatus 1100 shown in FIG. 11 may be configured to: implement steps or operations implemented by the network device in the foregoing method embodiments, and achieve effects corresponding to the network device. For an embodiment of the communication apparatus 1100 shown in FIG. 11, refer to the descriptions in the foregoing method embodiments. Details are not described herein again.

An embodiment further provides a non-transitory computer-readable storage medium. The storage medium is configured to store one or more computer-executable instructions. When the computer-executable instructions are executed by a processor, the processor performs the method in the possible embodiments of the first device or the second device in the foregoing embodiments.

An embodiment further provides a computer program product (or referred to as a computer program). When the computer program product is executed by a processor, the processor performs the method in the possible embodiments of the first device or the second device.

An embodiment further provides a chip system. The chip system includes at least one processor, configured to support a communication apparatus in implementing a function in the possible embodiments of the communication apparatus. Optionally, the chip system further includes an interface circuit, and the interface circuit provides program instructions and/or data for the at least one processor. In a possible embodiment, the chip system may further include a memory. The memory is configured to store program instructions and data that are necessary for the communication apparatus. The chip system may include a chip, or may include a chip and another discrete component. The communication apparatus may be the first device or the second device in the foregoing method embodiments.

An embodiment further provides a communication system. An architecture of the network system includes the first device and the second device in any one of the foregoing embodiments. The first node may be a terminal device or a network device, and the second device may also be a terminal device or a network device.

In the several embodiments, it should be understood that the system, apparatus, and method may be implemented in other manners. For example, the described apparatus embodiment is an example. For example, division into the units is logical function division and may be other division in some embodiments. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, and may be located in one position, or may be distributed on a plurality of network units. A part or all of the units may be selected based on some requirements to achieve the objectives of the solutions of embodiments.

In addition, functional units in embodiments may be integrated into one processing unit, or each of the units may exist alone physically, or two or more units may be integrated into one unit. The integrated unit may be implemented in a form of hardware, or may be implemented in a form of a software functional unit. When the integrated unit is implemented in the form of the software functional unit and sold or used as an independent product, the integrated unit may be stored in a non-transitory computer-readable storage medium. Based on such an understanding, the solutions of embodiments, or the part making contribution, or all or a part of the solutions may be implemented in the form of a software product. The computer software product is stored in a storage medium and includes several instructions for instructing a computer device (which may be a personal computer, a server, or a network device) to perform all or a part of the steps or operations of the methods described in embodiments. The storage medium includes any medium that can store program code, such as a USB flash drive, a removable hard disk drive, a read-only memory (ROM), a random access memory (RAM), a magnetic disk, or an optical disc.

1. A method, comprising:
determining first information, wherein the first information indicates channel characteristic information between a first device and a second device, the channel characteristic information comprises at least one of a channel eigenvalue or a channel eigenvector, and the first information is obtained by a first neural network by processing channel information of the first device; and
sending the first information to the second device.

2. The method according to claim 1, wherein the first neural network comprises a first module, a second module, and a third module, wherein
the first module is used to perform randomized range finder (RRF) processing on the channel information of the first device to obtain an RRF result; the second module is used to perform low rank approximation (LRA) processing on the channel information of the first device and the RRF result to obtain an LRA result; and the third module is used to perform singular value decomposition (SVD) processing on the LRA result to obtain the first information.

3. The method according to claim 2, wherein a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter; and
a value of l is less than that of m.

4. The method according to claim 2, wherein the first module comprises a first submodule, a second submodule, and a third submodule, wherein
the first submodule is used to perform data preprocessing on the channel information of the first device based on a preprocessing parameter, to obtain a preprocessing result; the second submodule is used to perform randomized neural network processing on the preprocessing result based on an oversampling parameter, to obtain a randomized neural network processing result; and the third submodule is used to perform orthogonal triangular (QR) decomposition processing on the randomized neural network processing result to obtain the RRF result.

5. The method according to claim 4, wherein the second submodule comprises a first sub-neural network and T second sub-neural networks, wherein T is an integer greater than or equal to 0; and
the first sub-neural network is used to perform a basic randomization operation of the randomized neural network processing, and each of the T second sub-neural networks is used to perform an enhanced randomization operation of the randomized neural network processing.

6. The method according to claim 1, wherein that the first information is obtained by the first neural network by processing the channel information of the first device comprises:
the first information is obtained by the first neural network by processing the channel information of the first device based on a first parameter, wherein the first parameter comprises at least one of an oversampling parameter or a preprocessing parameter.

7. The method according to claim 4, further comprising:
receiving indication information indicating at least one of the oversampling parameter or the preprocessing parameter.

8. The method according to claim 4, further comprising:
sending indication information indicating at least one of the oversampling parameter or the preprocessing parameter.

9. A method, comprising:
determining K pieces of first information, wherein the K pieces of first information respectively indicate channel characteristic information between K first devices and a second device, the channel characteristic information comprises at least one of a channel eigenvalue or a channel eigenvector, each piece of the K pieces of first information is obtained by a first neural network by processing channel information of a corresponding one of the K first devices, and K is an integer greater than or equal to 1; and
communicating with at least one of the K first devices based on the K pieces of first information.

10. The method according to claim 9, wherein the first neural network comprises a first module, a second module, and a third module, wherein
the first module is used to perform randomized range finder (RRF) processing on the channel information of the first device to obtain an RRF result; the second module is used to perform low rank approximation (LRA) processing on the channel information of the first device and the RRF result to obtain an LRA result; and the third module is used to perform singular value decomposition (SVD) processing on the LRA result to obtain the first information.

11. The method according to claim 10, wherein a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter; and
a value of l is less than that of m.

12. The method according to claim 10, wherein the first module comprises a first submodule, a second submodule, and a third submodule, wherein
the first submodule is used to perform data preprocessing on the channel information of the first device based on a preprocessing parameter, to obtain a preprocessing result; the second submodule is used to perform randomized neural network processing on the preprocessing result based on an oversampling parameter, to obtain a randomized neural network processing result; and the third submodule is used to perform orthogonal triangular (QR) decomposition processing on the randomized neural network processing result to obtain the RRF result.

13. The method according to claim 12, wherein the second submodule comprises a first sub-neural network and T second sub-neural networks, wherein T is an integer greater than or equal to 0; and
the first sub-neural network is used to perform a basic randomization operation of the randomized neural network processing, and each of the T second sub-neural networks is used to perform an enhanced randomization operation of the randomized neural network processing.

14. The method according to claim 9, wherein that the first information is obtained by the first neural network by processing the channel information of the first device comprises:
the first information is obtained by the first neural network by processing the channel information of the first device based on a first parameter, wherein the first parameter comprises at least one of an oversampling parameter or a preprocessing parameter.

15. The method according to claim 12, further comprising:
receiving indication information indicating at least one of the oversampling parameter or the preprocessing parameter.

16. The method according to claim 12, further comprising:
sending indication information indicating at least one of the oversampling parameter or the preprocessing parameter.

17. A communication apparatus, comprising at least one processor, and one or more memories coupled to the at least one processor and storing programming instructions for execution by the at least one processor to perform operations comprising:
determining first information, wherein the first information indicates channel characteristic information between a first device and a second device, the channel characteristic information comprises at least one of a channel eigenvalue or a channel eigenvector, and the first information is obtained by a first neural network by processing channel information of the first device; and
sending the first information to the second device.

18. The communication apparatus according to claim 17, wherein the first neural network comprises a first module, a second module, and a third module, wherein
the first module is used to perform randomized range finder (RRF) processing on the channel information of the first device to obtain an RRF result; the second module is used to perform low rank approximation (LRA) processing on the channel information of the first device and the RRF result to obtain an LRA result; and the third module is used to perform singular value decomposition (SVD) processing on the LRA result to obtain the first information.

19. The communication apparatus according to claim 18, wherein a matrix dimension of a matrix representation of the channel information of the first device is m×n, a matrix dimension of a matrix representation of the LRA result is l×n, m is a quantity of antenna ports of the second device, n is a quantity of antenna ports of the first device, and l is an oversampling parameter; and
a value of l is less than that of m.

20. The communication apparatus according to claim 18, wherein the first module comprises a first submodule, a second submodule, and a third submodule, wherein
the first submodule is used to perform data preprocessing on the channel information of the first device based on a preprocessing parameter, to obtain a preprocessing result; the second submodule is used to perform randomized neural network processing on the preprocessing result based on an oversampling parameter, to obtain a randomized neural network processing result; and the third submodule is used to perform orthogonal triangular (QR) decomposition processing on the randomized neural network processing result to obtain the RRF result.
